(19) United States
(12) Patent Application Publication
(10) Pub. No.: US 2018/0212565 A1
(43) Pub. Date: Jul. 26, 2018

(54) ALIGNMENT FEATURES FOR A PHOTOVOLTAIC ROOFING SYSTEM AND A METHOD OF FORMING A PHOTOVOLTAIC ROOFING SYSTEM

(71) Applicant: Dow Global Technologies LLC, Midland, MI (US)

(72) Inventors: Leonardo C. Lopez, Midland, MI (US); Joseph A. Langmaid, Caro, MI (US); Gerald K. Eurich, Merrill, MI (US); John C. McKeen, Hope, MI (US)

(21) Appl. No.: 15/745,684

(22) PCT Filed: Jul. 5, 2016
(86) PCT No.: PCT/US16/40934

§ 371 Date: Jan. 17, 2018

Related U.S. Application Data
(60) Provisional application No. 62/194,445, filed on Jul. 20, 2015.

(51) Int. Cl. H02S 99/00; G09F 3/00; F16B 45/00

(52) U.S. Cl. CPC H02S 99/00; H02S 20/23; F16B 45/00; G09F 3/00

(57) ABSTRACT

A photovoltaic array system comprising: (a) a plurality of photovoltaic components that are configured to be connected together; and (b) one or more alignment features located on at least two of the plurality of photovoltaic components; wherein the one or more alignment features are located in a side edge region of at least one of the plurality of photovoltaic components and in a top edge region of at least one of the plurality of photovoltaic components, and the one or more alignment features indicate when two or more of the plurality of photovoltaic components are aligned relative to each other so that the two or more photovoltaic components can be mated together to form a fixed connection.

### FIELD

The present teachings generally relate to an alignment features for forming a photovoltaic roofing system and a method of forming a photovoltaic roofing system using the alignment features.

### BACKGROUND

Typically, photovoltaic arrays are placed in an elevated location such as a roof top of a home or a building or in a rack and frame that elevates the photovoltaic array so that the photovoltaic array is exposed to sunlight. The roofs on homes and/or buildings generally are formed by adding a plurality of pieces of panels together so that a generally contiguous surface is formed, which are supported by one or more trusses. Photovoltaic modules may be secured to the plurality of pieces of panels directly and/or indirectly via a connection structure such as a rack and frame. Each photovoltaic module of the photovoltaic array may include only an active portion and the active portions of two or more photovoltaic modules may be placed in close proximity with one another so that a photovoltaic array is formed over and/or on the connection structure. However, in cases where the photovoltaic modules provide roofing functions, the photovoltaic modules may include both an active portion and a support portion and the active portion of one photovoltaic module may fully and/or partially cover the support portion of an adjacent photovoltaic module to replace the framing and racking structure. The active portion and the support portion may be one integrally formed piece with the photovoltaic active portion located within the active portion so that in order to remove the photovoltaic active portion the entire photovoltaic module would be removed and replaced if necessary. In cases of building integrated photovoltaics, the support portion may provide roofing functions or structural functions for subsequent photovoltaic modules. The photovoltaic modules each have a portion that is directly connected to the roofing structure. Each photovoltaic module may also include a device that interconnects the photovoltaic modules together. This device may be added after the photovoltaic modules are connected to the roofing structure. This device may also be visible when the photovoltaic array is complete. The visibility of these devices may detract from the aesthetics of the photovoltaic array, these devices may become lost during installation, and these devices may increase installation time and expense.

Examples of some photovoltaic modules and photovoltaic arrays may be found in U.S. Pat. Nos. 8,584,407 and 8,898,970 U.S. Patent Application Publication No. 2012/0118349; and International Patent Application No. WO2013/019628 all of which are incorporated by reference herein for all purposes.

It would be attractive to have a system that conceals connection members so that the connection members connect two or more photovoltaic components together without the connection members being visible. It would be attractive to have an alignment feature that allows for blind installation of connection members. What is needed is a device that aligns two or more connection members together and indicates when the connection members are in a locked configuration. What is needed is an alignment feature that aligns two or more or even three or more photovoltaic components so that a connection can be made between the three or more photovoltaic components.

### SUMMARY

The present teachings meet one or more of the present needs by providing: a photovoltaic array system comprising: (a) a plurality of photovoltaic components that are configured to be connected together; and (b) one or more alignment features located on at least two of the plurality of photovoltaic components; wherein the one or more alignment features are located in a side edge region of at least one of the plurality of photovoltaic components and in a top edge region of at least one of the plurality of photovoltaic components, and the one or more alignment features indicate when two or more of the plurality of photovoltaic components are aligned relative to each other so that the two or more photovoltaic components can be mated together to form a fixed connection.

The present teachings provide a method of a photovoltaic array comprising: placing one or more photovoltaic components in a first row or column; placing one or more photovoltaic components in a second row or column that at least partially overlaps the first row or column; aligning the one or more photovoltaic components in the second row or column with the one or more photovoltaic components in the first row or column using one or more alignment features; locking the one or more photovoltaic components in the second row or column to the one or more photovoltaic components in the first row or column by moving the one or more photovoltaic components in the second row or column relative to the one or more alignment features.

The teachings herein surprisingly solve one or more of these problems by providing a system that conceals connection members so that the connection members connect two or more photovoltaic components together without the connection members being visible. The present teachings provide an alignment feature that allows for blind installation of connection members. The present teachings provide a device that aligns two or more connection members together and indicates when the connection members are in a locked configuration. The present teachings provide an alignment feature that aligns two or more or even three or more photovoltaic components so that a connection can be made between the three or more photovoltaic components.

### BRIEF DESCRIPTION OF THE DRAWINGS

FIG. 1 illustrates a top perspective view of a photovoltaic array;

FIG. 2 illustrates partial cross-sectional view of the photovoltaic array of FIG. 1;

FIG. 3 illustrates an exploded view of a photovoltaic array;

FIG. 4 illustrates a bottom view of connection members connected together;

FIG. 5 illustrates a cross-sectional view of two overlapped photovoltaic modules and the connection members mated together;

FIG. 6 illustrates a top view of a portion of a photovoltaic array;

FIG. 6A illustrates a close-up view of alignment features;

FIG. 7 illustrates a top perspective view of a top right plus piece;

FIG. 8 illustrates a top perspective view of a top right minus piece;

FIG. 9 illustrates a top perspective view of a bottom piece;

FIG. 10 illustrates a close-up view of an alignment feature of FIG. 9;

FIG. 11 illustrates a top perspective view of a bottom right plus piece;

FIG. 12 illustrates a top perspective view of a bottom left plus piece;

FIG. 13 illustrates a top perspective view of a row to row left piece;

FIG. 14 illustrates a top perspective view of a top piece;

FIG. 15 illustrates a top perspective view of a top left minus piece;

FIG. 16 illustrates a top perspective view of a top left plus piece;

FIG. 17 illustrates a top perspective view of a step in right piece;

FIG. 18 illustrates a top perspective view of a step in left piece;

FIG. 19 illustrates a top perspective view of a row to row right piece;

FIG. 20 illustrates a top perspective view of a photovoltaic module;

FIG. 21 illustrates a close-up top plan view of a photovoltaic module;

FIG. 22 illustrates a top perspective view of a bottom right minus piece; and

FIG. 23 illustrates a top perspective view of a bottom left piece.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled.

A plurality of photovoltaic components (e.g., active components and flashing components) of the teachings herein are combined together to form a photovoltaic array. The photovoltaic array collects sunlight and converts the sunlight to electricity. Generally, each of the active components (e.g., photovoltaic modules) may be individually placed in a structure that houses all of the photovoltaic modules forming all or a portion of a photovoltaic array. Preferably, each individual photovoltaic component may be connected directly to a structure (i.e., is a building integrated photovoltaic (BIPV)) and each of the individual photovoltaic components is electrically connected together so that a photovoltaic array is formed. The photovoltaic components may be connected to a support structure that forms a connection surface.

The connection surface may function to provide support to one or more photovoltaic components so that a photovoltaic array is formed. The connection surface may be a support structure such as a housing for containing one or more of the photovoltaic components. Preferably, the connection surface may be a roof. The roof may be made of any material that has sufficient strength to support the weight of the plurality of photovoltaic modules. The roof may be made of any material so that the plurality of photovoltaic modules may be directly connected to the roof. The plurality of photovoltaic components may be connected to the connection surface so that the photovoltaic components are adjacent to one another. For example, an edge of one photovoltaic components may be located substantially proximate to an edge of an adjoining photovoltaic components. Preferably, the photovoltaic components may partially overlap each other. For example, the active portion and/or a support portion of one photovoltaic module may overlap an overlap portion of one or more adjacent photovoltaic modules in a similar fashion to how roofing shingles are applied to a roof. Preferably, a support portion of a base plate of one photovoltaic module may extend at least partially over an overlap portion of an adjacent base plate.

The photovoltaic components may be aligned in rows (e.g., horizontally) or columns (e.g., vertically), but as discussed herein both rows and columns will be referred to as rows. The photovoltaic array may include two or more rows, three or more rows, four or more rows, or even five or more rows. Preferably, the photovoltaic array may include a plurality of rows. The combination of rows of photovoltaic components when connected together form a photovoltaic array that includes a peripheral edge. The peripheral edge is the outer edge that extends around an outer most region of the photovoltaic array. The photovoltaic components may be staggered from row to row. For example, an upper photovoltaic component may overlap a portion of two or more lower photovoltaic components. Preferably each photovoltaic component is staggered and overlaps two photovoltaic components and each of the overlapped photovoltaic components has a portion that extends outside of the overlapping photovoltaic component. Each of the photovoltaic components either overlaps one or more adjacent photovoltaic components, are overlapped by one or more adjacent photovoltaic components, or both overlap and is overlapped by one or more adjacent photovoltaic components. The overlap may form a double overlap so that each of the photovoltaic components is covered forming a shingle effect. The active components and the flashing components may connect together in an overlapped fashion forming the photovoltaic array as set forth herein.

Each of the photovoltaic components function to form a portion of the photovoltaic array that prevents the ingress of water. Each of the photovoltaic components functions to serve a roofing function. The photovoltaic components may each include a surface that removes water from the roofing structure, prevents water from penetrating into the photovoltaic array. Each photovoltaic component may be connectable to one or more adjacent photovoltaic components so that a water tight seal is formed. Each of the photovoltaic components include a peripheral edge. The peripheral edge is an edge that extends about a perimeter of each photovoltaic component The peripheral edge may overhang any connection members of the photovoltaic components. The peripheral edge may overhang the connection members so that connection members are not visible from the top. The peripheral edge may overhang the connection members so that during installation the installation is a “blind” installation. The connection members may be located in a central region of the photovoltaic components.

The connection members may function to connect two or more photovoltaic components together. The connections members may function to mate together and prevent fluid from passing through the photovoltaic array. The connection members may prevent wind uplift. The connection members may prevent lateral movement, longitudinal movement, vertical movement, or a combination thereof of two or more connected photovoltaic components. The connection members may be a male and female component. The connection members may form a mating relationship. The connection members may be a connection hook, a connection recess, or both. Each photovoltaic component includes at least one connection member. Each photovoltaic component may include a plurality of connection members. Some photovoltaic components may include only a connection hook or only a connection recess. Some photovoltaic components include both connection hooks and connection recesses. For example, a photovoltaic component may include a plurality of connection recesses in an overlap portion and a plurality of connection hooks in an active portion or a cap portion.

The one or more connection recesses may function to connect two or more adjacent photovoltaic components, two or more adjacent base plates, two or more photovoltaic modules, two or more flashing components, two or more active components, a flashing component and an active component, or a combination thereof together. The one or more connection recesses may prevent movement of two or more active components, two or more photovoltaic modules, two or more flashing components, or a combination thereof relative to each other. The one or more connection recesses may function to receive a portion of an adjacent photovoltaic component. The one or more connection recesses may extend along a width of the photovoltaic component. The one or more connection recesses may extend transverse to the slope of the roof. The one or more connection recesses may be located in the overlap portion, the support portion, the cap portion, or a combination thereof. The one or more connection recesses may be spaced apart along the photovoltaic component so that the connection recesses may receive a portion of two or more adjacent photovoltaic components (e.g., a connection hook). The one or more connection recesses may be located along edges but inside of the edge, in edge regions, in a central region, or a combination thereof of the photovoltaic components. Preferably the connection recesses are evenly spaced out across the base plate, the photovoltaic module, or both. The one or more connection recesses may be a plurality of connection recesses that each receives a portion of an adjacent photovoltaic component (e.g., each connection recess may receive a connection hook). The one or more connection recesses may be a through hole that extends through the photovoltaic component (e.g., flashing component or base plate). The one or more connection recesses may be visible from the top of the photovoltaic component. However, when another photovoltaic component extends over the connection recess the connection recess may be obscured from view. Thus, an installer may not be able to see the connection recess during installation. The connection recesses may be a recess in the photovoltaic component that does not extend through the photovoltaic component. The one or more connection recesses may be any shape that may receive a portion of an adjacent photovoltaic component so that the photovoltaic components are locked relative to each other, movement relative to each other is prevented, or both. The one or more connection recesses may include one or more walls that create a border around the connection recesses.

The one or more walls may function to support an adjacent photovoltaic module above the connection recess. The one or more walls may function to prevent fluid from entering into the connection recess. The one or more walls may be an elevated surface that extends from the base plate proximate to the connection recesses. The walls may extend sufficiently high so that the walls contact a bottom side of an adjacent photovoltaic component and the bottom side acts as a lid. The walls may be one unitary structure that extends from the photovoltaic component (e.g., vertically away from a top surface of the photovoltaic component). The walls may assist in creating a fixed connection with an adjacent photovoltaic module. The walls may assist in placing two adjacent photovoltaic components in tension.

The one or more connection hooks may function to prevent movement (e.g., vertical, horizontal, longitudinal, diagonal, or a combination thereof) of two or more photovoltaic components, two or more photovoltaic modules, two or more active components, two or more flashing components, at least one flashing component and at least one active component, or a combination thereof relative to each other. The connection hooks may mate with the connection recesses to function to prevent movement of two or more photovoltaic components relative to each other. The one or more connection hooks may prevent wind uplift. The one or more connection hooks may extend into a connection recess. The one or more connection hooks may be complementary to the one or more connection recesses. The one or more connection hooks may extend through a connection recess. The one or more connection hooks may contact a portion of the connection recess, an area adjacent to the connection recess, a rear side of the photovoltaic components, the photovoltaic module, a rib, or a combination thereof. The one or more connection hooks may extend through the connection recess and then turn and contact a portion of the photovoltaic components, an opposing side, an internal wall, or a combination thereof. The one or more connection hooks may extend into the connection recess and contact a portion of the inside of the connection recess. The one or more connection hooks may be smaller than the connection recess. A gap may be located on one or both sides, one or both edges, or both of the connection hooks. The one or more gaps may allow the connection hooks to extend into the connection recess without being completely aligned (e.g., during blind installation). The gaps may be sufficiently large so that the connection hooks can move side to side in the connection recess during formation of a connection. The one or more connection hooks may extend into the connection recess and into contact with a rib or wall that puts tension of the connection hook so that the photovoltaic component is prevented from lifting. The one or more connection hooks may be located along edges but inside of the edge, in edge regions, in a central region, or a combination thereof of the base plate. Preferably the connection hooks are substantially evenly spaced out across the photovoltaic components. The photovoltaic components may include two or more, three or more, four or more, or even five or more connection hooks.

The one or more connection hooks may have a portion that extends in the direction of the slope of the connection structure, opposite the slope or the connection structure, perpendicular to the direction of the slope of the connection structure, or a combination thereof. The one or more connection hooks may extend from a rear side of the photovoltaic components. The one or more connection hooks may be substantially obscured from view when the photovoltaic component is viewed from the top or a top perspective view due to the connection hooks being located inside of a peripheral edge, in a central region, or both. The one or more connection hooks may include one or more lock features. The one or more lock features may form a fixed connection with a connection recess, a rib, a wall, or a combination thereof. The one or more lock features may function to provide an indication that a lock is formed. The one or more lock features may function to provide resistance when detaching the connection hook from the connection recess. The one or more connection hooks may be on an opposite side of the base plate as the handles, on an opposite end of the overlap portion as the handles, or both. The one or more connection members may be located proximate to one or more fastener supports.

The fastener supports may be located within the active portion, the overlap portion, the support portion, cap portion, in the photovoltaic components, or a combination thereof. Preferably, the fastener supports may be located within the overlap portion. The fastener supports may be a through hole that extends through the overlap portion, a weakened area so that a fastener may be placed through the fastener support, a removable portion, a punch out, an area of lower hardness, or a combination thereof. The one or more fastener supports and preferably a plurality of fastener supports may be located in the support portion, the overlap portion, or both of the base plate, the flashing components, the active components, or a combination thereof. The one or more fastener supports may accept one or more fasteners.

The plurality of photovoltaic components may be connected to the connection surface by any fastener that has sufficient strength to withstand environmental conditions and form a secure connection. The plurality of photovoltaic components may be connected to a connection surface with a mechanical fastener, an adhesive, an interlocking connection with an adjacent photovoltaic module, or a combination thereof. The fasteners may be a screw, nail, bolt, staple, rivet, or a combination thereof. The adhesive may be any adhesive with sufficient strength to connect the photovoltaic components to the connection surface. The adhesive may be epoxy based, silicone based, acrylic based, a urethane based, a polyamide based, a one part adhesive, a multi-part adhesive, a natural adhesive, a synthetic adhesive, a butyl rubber, polyolefin based adhesive, or a mixture thereof. The fastener may be a combination of a mechanical fastener and an adhesive fastener. The connection may be a permanent connection, a removable connection, or both so that photovoltaic components are connected to a connection surface. The photovoltaic components may be lightweight and have a low profile so that the photovoltaic components may be connected directly to the connection surface by the fasteners as are discussed herein. The one or more fastener supports and fasteners may be located outside of the connector channels so that connectors may extend into and be removed from the connector channels.

The one or more connector channels may function to receive the one or more connectors of the pv laminate, one or more row to row connectors, one or more photovoltaic component to photovoltaic component connectors, or a combination thereof (hereinafter all referred to as connectors). The one or more connector channels may function to protect the pv laminate connectors from contact, a lateral force, a longitudinal force, an impact, or a combination thereof. The one or more connector channels may assist in forming a connection between a connector (e.g., that connects two adjacent photovoltaic modules) and connector of a pv laminate. The one or more connector channels may assist in forming a connection between a row to row connector (i.e., a connector in a row to row flashing piece) and a photovoltaic laminate. The one or more connector channels may assist in electrically connecting two adjacent pv laminate connectors, two adjacent photovoltaic components, a photovoltaic component to an inverter, or a combination thereof. The one or more connector channels may be a recess that receives the connector of the pv laminate. The one or more connector channels may be located on opposite edges, in opposing edge regions, on opposite sides, or a combination thereof of the base plate of a photovoltaic module.

The one or more base plates may function to support a photovoltaic laminate. The one or more base plates may function to protect a roofing structure from fluids. Each base plate may include a support portion, an active portion, and an overlap portion. The active portion may overlap all or a portion of one or more adjacent photovoltaic components, one or more flashing components, or both (e.g., the overlap portion) forming a “double overlap” so that each photovoltaic module may be protected and connected to a connection surface and/or so that the combined photovoltaic components may form a shingle structure for diverting fluids from the roof of the structure. Each of the photovoltaic modules may have a portion that may be indirectly and/or directly connected to a connection surface. The base plate may directly connect to a connection surface and the photovoltaic laminate may be connected to a support portion of the base plate (i.e., the photovoltaic laminate may be indirectly connected to the connection surface). Preferably, the overlap portion of each of the photovoltaic modules may be directly connected to a connection surface, and the active portion may be connected directly to the overlap portion or directly to the connection surface by a fastener that extends through the overlap portion, around the overlap portion, through a fastener support in the overlap portion, or a combination thereof. More preferably, each of the photovoltaic modules may include a base plate and a photovoltaic laminate and the base plate is connected to a connection surface by one or more fasteners that extend through fastener supports and preferably a plurality of fasteners that extend through fastener supports.

The base plate may be connected to the support structure and function to provide roofing functions. The base plate may function to connect a photovoltaic laminate (hereinafter pv laminate) to a connection surface (e.g., a roof). The base plate may function to allow for decoupled expansion and contraction of the pv laminate relative to the base plate or vice versa. The base plate may function to allow for removal, replacement, repair, or a combination thereof of the pv laminate without removal of the entire pv module from the connection surface. The base plate may connect the pv laminate to a connection surface. The base plate may protect one or more connectors and or wiring. The base plate may retain roofing functions, fire retardant properties, or both when the pv laminate is removed from the base plate. The base plate may include an active portion and an overlap portion. The base plates, photovoltaic components, flashing components, or a combination thereof may include one or more handles.

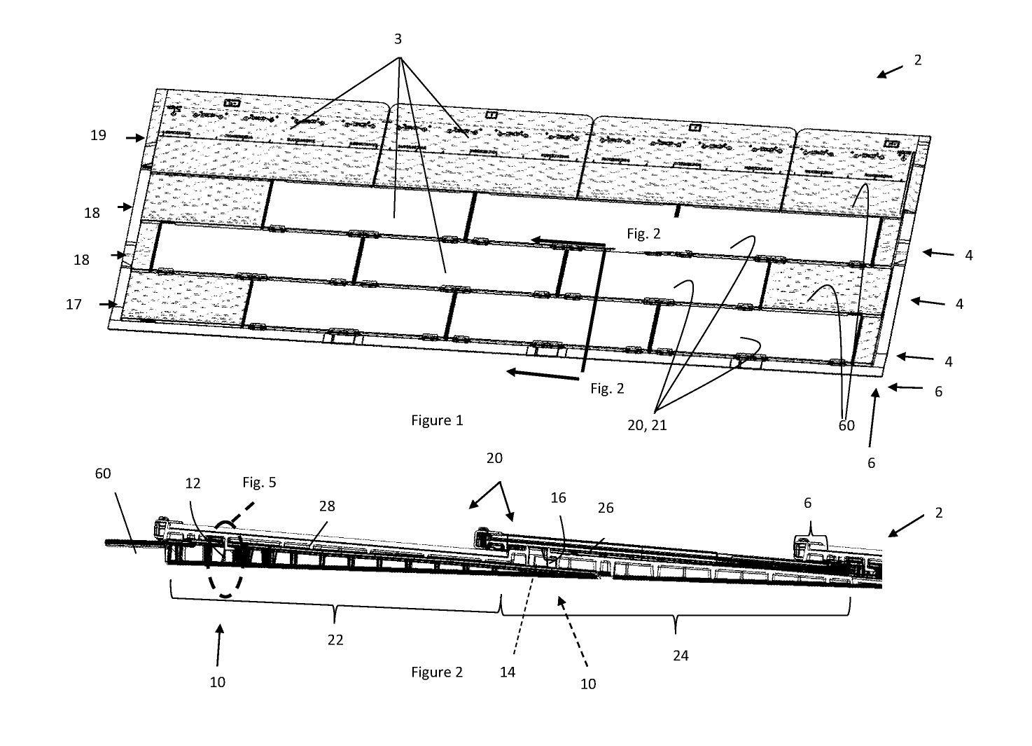

The one or more handles may function to provide a carrying location for the photovoltaic components. The one or more handles may function to provide a location to lift the photovoltaic components. The one or more handles may be a through hole that extends through the photovoltaic components (e.g., photovoltaic module, base plate, flashing components). The one or more handles may assist in forming a connection between two or more adjacent photovoltaic components. The one or more handles may align with another structure of one or more adjacent photovoltaic components. The one or more handles may extend through one or more ribs. The one or more handles as taught herein may include teachings from U.S. Provisional Patent Application No. 61/856,125, filed on Jul. 19, 2013 the teachings of which are expressly incorporated by reference herein in their entirety and especially the teachings of paragraph nos. 0029 to 0057 and FIGS. 1-10C as to the mating features, male component, female component, through hole, and projection. The handles may be located in an overlap portion.

The overlap portion may function to receive a portion of one or more photovoltaic components. The overlap portion may function to provide support to one or more photovoltaic components. The overlap portion may be covered by a photovoltaic module, a photovoltaic component, a flashing component, or a combination thereof. The overlap portion may be directly connected to a support structure. The overlap portion may include one or more connection recesses. The overlap portion may be adjacent one or more active portions, support portion, cap portions, or a combination thereof.

The support portion may function to provide support to one or more pv laminates, one or more adjacent photovoltaic components, or both. Preferably, the support portion may support one or more pv laminates during transportation, installation, or both. The support portion may function to support the pv laminate when a load is applied to the pv laminate when the pv laminate is connected to a connection surface. For example, when the photovoltaic module is connected to a roof and a person walks across the photovoltaic array the support portion may resist bending of the pv laminate so that the pv laminate is not damaged. The support portion may function to provide support for one or more adjacent photovoltaic modules. The support portion of a first photovoltaic component may function to overlap one or more connectors of one or more second adjacent photovoltaic modules so that the one or more connectors of the one or more second adjacent photovoltaic modules are protected. The support portion of a first photovoltaic module may protect one or more connectors that are connected to and extend between two adjacent second photovoltaic modules. The support portion may protect the laminate from penetration by foreign objects from the backside. Preferably, the support portion and the pv laminate may be connected. More preferably the support portion and the pv laminate may be movable relative to each other when the pv laminate is connected to the support portion. The support portion may be part of an active component.

The active portion may function to generate electricity when a pv laminate is connected to the base portion. The active portion may be a portion of the pv laminate that is not covered by one or more adjacent photovoltaic modules. The active portion may be a combination of a support portion of the base plate and a pv laminate. The active portion and the support portion may be part of the photovoltaic module as discussed herein and the cap portion may be part of the flashing component as discussed herein. The one or more photovoltaic components may include a portion that is made of a polymeric composition and the polymeric composition may include the handles, ribs, or both.

The polymeric composition of the photovoltaic components (e.g., active components and flashing components) may have low shrinkage, result in an uniform elastic modulus between a length and width, or a combination of both. The polymeric composition may be any polymeric composition that may be flowable, have high electrical insulating properties, fluid impermeable, high flexibility, low creep, low modulus, fire retardant, or a combination thereof. Some polymeric compositions that may be used with the photovoltaic module taught herein are an elastomer, thermopolastic, thermosetting polymer, or a combination thereof. The polymeric composition may include a filled or unfilled moldable plastic, polyolefins, acrylonitrile butadiene styrene (SAN), hydrogenated styrene butadiene rubbers, polyester amides, polysulfone, acetal, acrylic, polyvinyl chloride, nylon, polyethylene terephthalate, polycarbonate, thermoplastic and thermoset polyurethanes, polyethylene, polystyrene, synthetic and natural rubbers, epoxies, polystyrene, thermoplastic elastomer (TPO, TPE, TPR), polyamides, silicones, vinyl based resins, or any combination thereof. The polymeric composition may be free of fillers, fibers, reinforcing materials, or a combination thereof. The polymeric composition may include fillers such as colorants, fire retardant (FR) or ignition resistant (IR) materials, reinforcing materials, such as glass or mineral fibers, surface modifiers, or a combination thereof. The polymeric composition may also include anti-oxidants, release agents, blowing agents, and other common plastic additives. Examples of suitable polymeric compositions are found in U.S. Patent Application Publication No. 2011/0100438 the contents of which are expressly incorporated by reference herein for the polymeric compositions.

An active component may be any component that includes an active portion that assists in generating power. The active component may convert sunlight to electricity. The active component may function to generate power. One preferable active component is a photovoltaic module as discussed herein. Preferably, the active component is any component that includes a pv laminate.

The one or more and preferably the plurality of pv laminates may be configured in any manner so that each of the plurality of active components (e.g., photovoltaic modules) may be electrically connected. The pv laminates may include a protective cover (e.g., a glass cover or a barrier plastic cover) and at least one pv cell (e.g., an electrical circuit). Each of the individual photovoltaic modules (i.e., the pv laminates in the photovoltaic modules) may be electrically connected to an adjacent photovoltaic module by one or more connectors. The one or more connectors may comprise a ribbon, a positive buss bar, a negative buss bar, a wire, a part of an integrated flashing piece, or a combination thereof. The connector may extend between two adjacent photovoltaic modules and forms an electrical connection. The connectors may assist in securing the two or more adjacent photovoltaic modules to a support structure. Preferably, the connectors do not assist in connecting the photovoltaic modules to a support structure and the photovoltaic modules are connected to the roof structure by a fastener. Preferably, the overlap support portion is free of connectors. The connectors may be a separate piece, a discrete piece, or both that connects two or more adjacent photovoltaic modules, integrated flashing pieces, or a combination of both. The connectors may extend from an active portion of the photovoltaic module, be part of a photovoltaic module, or both. The connectors may be an integral part of a pv laminate.

The photovoltaic laminate may be connected to a base plate, a support portion of the base plate, or both and form an active portion. The photovoltaic module includes an active portion and a support portion. The active portion and the support portion may be the same region of the base plate. The active portion may be any portion of the photovoltaic module that produces electricity when the active portion is in contact with sunlight. The pv laminate may be made of any material so that when sunlight is directed on the active portion the sunlight is converted into electricity. The pv laminate may be made of one or more photovoltaic cells having a photoactive portion. Preferably, the pv laminate may be made of a plurality of photovoltaic cells. The photovoltaic cells may be made of any material that assists in converting sunlight into electricity. The photovoltaic cells may be of any type and material known in the art. Some non-limiting examples of materials that the photovoltaic cells may be made of include crystalline silicon, amorphous silicon, cadmium telluride (CdTe), gallium arsenide (GaAs), copper chalcogenide type cells (e.g. copper gallium selenides, copper indium gallium selenides (CIGS), copper indium selenides, copper indium gallium sulfides, copper indium sulfides (CIS), copper indium gallium selenide sulfides, etc. (i.e., known generally as CIGSS)), thin-film III-V cells, thin-film II-VI cells, IB-IIIA-chalcogenide (e.g., IB-IIIA-selenides, IB-IIIA-sulfides, or IB-IIIA-selenide sulfides), organic photovoltaics, nanoparticle photovoltaics, dye sensitized photovoltaic cells, and/or combinations of the described materials. In one specific example, the copper indium gallium selenides may be represented by the formula CuIn(1-x)GaxSe(2-y)Sy where x is 0 to 1 and y is 0 to 2. For copper chalcogenide type cells, additional electroactive layers such as one or more of emitter (buffer) layers, conductive layers (e.g. transparent conductive layers) or the like maybe used in CIGSS based photovoltaic cells are contemplated by the teachings herein. The active portion may be flexible or rigid and come in a variety of shapes and sizes, but generally are fragile and subject to environmental degradation. In a preferred embodiment, the active portion is a cell that can bend without substantial cracking and/or without significant loss of functionality. Other materials and/or combinations are contemplated herein especially those compositions disclosed in paragraph 0054 of U.S. Patent Application Publication No. 2012/0118349, which is incorporated herein by reference as to materials for the active portion. The photovoltaic cells of the photovoltaic laminate may be arranged in parallel, series, mixed series-parallel, and/or may be provided in independent circuits. The photovoltaic laminate may be a combination of layers and may form an assembly.

The pv laminate assembly may include one or more of the following components: a forward protective layer, a rearward protective layer, a reinforcement, a photovoltaic cell, a peripheral moisture sensitive edge seal, one or more internal protecting layers, dielectric materials as may be needed to manage the penetration of electrical components outside the laminate, attached connectors and wiring boxes, connector support structures including junction boxes, integrated low profile connectors, encapsulants, moisture resistant back sheets that may optionally include metallized sub layers, or a combination thereof. One example of a pv laminate may include a top layer of glass or a polymeric moisture barrier, an encapsulant layer, an electrical assembly comprising cells, bypass diodes and busses, a rear encapsulant layer, an aluminum based multi-layer back sheet, another encapsulant layer, a rearward protective layer, additional layers around the connector area including a connector support structure, an encapsulant, a dielectric layer, a connector sealant material such as an adhesive with a moisture barrier or another adhesive sealant or potting material, the low profile connector attached to the cells with bus terminals, another layer of encapsulant, and another dielectric layer. The rearward protective layer may help protect the laminate from any protrusions or abrasion from the support structure of the base plate. The pv laminate assembly may be free of an encapsulant layer, a rearward protective layer, or both. One or more of the layers discussed herein may be a combination of layers. For example, a forward protective layer may be a combination of multiple glass layers combined together. As another example, the reinforcement may be a plurality of layers bonded together. The layers of pv laminate assembly may be laminated together. The layers of the pv laminate may be sealed at the edges. Preferably, the pv laminate has a peripheral sealed edge that is resistant to fluid penetration. As discussed herein, each individual layer may include an adhesive so that one or more layers are bonded together forming a layer, each layer may include an adhesive over and/or under another layer so that the one or more adjacent layers are bonded together. Other components and layers of the photovoltaic module are contemplated herein that may be used with the reinforcement taught herein especially those components, layers, and/or materials disclosed in Paragraph Nos. 0048-0053 of U.S. Patent Application Publication No. 2012/0118349, and Paragraph Nos. 0027-0038 and FIGS. 2A and 2B 2011/0220183, both of which are expressly incorporated herein by reference as to components, layers, and/or materials for active portions that may be used in conjunction with the reinforcement and photovoltaic module discussed herein. One or more of the layers of the pv laminate may be electrical circuitry. The electrical circuitry may be sealed within the pv laminate.

The electrical circuitry of the photovoltaic laminate may be one or more buss bars, one or more ribbons, or both. The electrical circuitry may extend from cell to cell, photovoltaic module to photovoltaic module, cell to a photovoltaic module, active portion to active portion, or a combination thereof. The electrical circuitry may be integrated into the one or more photovoltaic cells, connect the one or more photovoltaic cells, be electrically connected to the one or more photovoltaic cells, or a combination thereof. The electrical circuitry may be integrated into and/or around one or more layers of the photovoltaic laminate. The electrical circuitry may extend through the photovoltaic laminate, extend partially outside of the photovoltaic laminate so that an electrical connection may be formed, have a portion that is located adjacent to the photovoltaic laminate, or a combination thereof. The photovoltaic laminate may be connected to a support portion of a base plate forming an adjacent portion. The pv laminate may include one or more connectors that are part of the electrical circuitry and extend outside of the pv laminate. The one or more connectors may have a portion that is sealed within the pv laminate and a portion that extends out of the pv laminate. The one or more connectors may be covered by one or more active components, one or more flashing components, or both.

The one or more flashing components may function to create a fluid impenetrable barrier. The one or more flashing components may function to cover one or more active components and prevent fluid from entering the photovoltaic array. The one or more flashing components may end one or more rows. The one or more flashing components may connect two or more rows. The one or more flashing components may have a portion that extends under and/or over an active component, under and/or over a standard roofing shingle, or both. The one or more flashing components may form a cap over one or more photovoltaic components. The one or more flashing components may be free of any active portion, any portion that produces power, or both. The one or more flashing components may include a pv laminate, an active portion, or both. The one or more flashing components may protect the active components. The one or more flashing components may connect one or more rows of active components together. The one or more flashing components may cover one or more through holes, handles, connection recesses, or a combination thereof in the active components, in other flashing components, or both. The one or more flashing components may prevent wind uplift. The one or more flashing components may create a tortuous path for water to enter the photovoltaic array in a direction opposite the slope of the roof. The one or more flashing components may seal the peripheral edge of the photovoltaic array. The edge of one or more of the flashing components may include one or more side ledges.

The flashing components may include one or more side ledges. Some of the flashing components may include one or more side ledges. Some of the flashing components may be free of side ledges. Flashing components may include a plurality of side ledges. The side ledges may extend the length of or more of the edges of the flashing components. The side ledges may connect to an adjacent side ledge to form a fluid barrier. The side ledges may mate with the standard shingles. A portion of the side ledges may extend under or over the standard shingles. A portion of the side ledges may extend over and into contact with the standard shingles (e.g., asphalt shingles, stucco shingles, clay shingles). The side ledges may be in communication with each other and form a peripheral edge around the photovoltaic array. The side ledges may prevent water from creeping under the flashing components, the active components, or both. The side ledges may be proximate to or opposite one or more flashing interfaces.

The one or more flashing interfaces may function to interface with standard shingles, roofing material, or both. The one or more flashing interfaces may prevent fluid from extending from the roof onto the photovoltaic array. The one or more flashing interfaces may guide water along a side of the photovoltaic array without the water entering onto the photovoltaic array. The flashing interface may overlap a standard shingle, a roofing material, or both. The flashing interface may be overlapped by a standard shingle, a roofing material, or both. A corner flashing piece may include two flashing interfaces. A center flashing piece may include one flashing interface. A row to row flashing piece may include one or more or even two or more flashing interfaces. The flashing interfaces may terminate at one or more flashing walls.

The one or more flashing walls may function to prevent fluid from ingress into the photovoltaic array. The one or more flashing walls may function to create a barrier that is taller than a standard roofing shingle, a roofing material, or both. The one or more flashing walls may prevent wind from blowing water under one or more photovoltaic components, blowing water from a standard roofing shingle unto the photovoltaic array, or both. The one or more flashing walls may be sufficiently tall that fluid cannot move from the standard roofing portion to the photovoltaic array. One or more edges of the photovoltaic array may include two or more flashing walls. One or more edges of the photovoltaic array may include a single flashing wall. The flashing interface may extend over standard roofing shingles at some locations and under standard roofing shingle in other locations. The flashing walls may terminate the flashing interfaces. The flashing walls may terminate at a flashing extension.

The one or more flashing extensions may function to form an overlapped connection with an adjacent flashing component. The one or more flashing extensions may function to create a water tight connection between two adjacent flashing components. The one or more flashing extensions may function as a locating feature, a partial locating feature, or both. The one or more flashing extensions may align with a flashing extension of another photovoltaic component. The one or more flashing extensions may interlock with a flashing extension of another flashing component. The flashing extensions may be part of a flashing interface. The flashing extensions prevent rain from being driven up (i.e., against the slope of the roof and/or photovoltaic array (e.g., from a bottom end towards a top end)) the photovoltaic array and under the one or more photovoltaic components. The one or more flashing extensions may extend under a flashing extension of an adjacent flashing component, under a main portion of a flashing component, or both. The one or more flashing extensions may extend over a flashing extension of an adjacent flashing component, under a main portion of a flashing component, or both. The one or more flashing extensions may extend the flashing interface beyond a main edge of the flashing component. When more than one flashing extension is present it is preferred that one is a male flashing extension and one is a female flashing extension. The female flashing extensions may include one or more pockets to receive one or more male flashing extensions.

The one or more pockets may function to create a water tight connection with an adjacent flashing extension. The one or more pockets may receive an adjacent flashing extension. The one or more pockets may include one or more flashing walls. The one or more pockets may be a recess that receives a flashing extension so that the flashing extension is flush with the other photovoltaic components. The one or more pockets may be located on starter row components only (i.e., the first row of photovoltaic components that are placed on a roof structure). One or more cap portions may be free of pockets.

The one or more cap portions may function to cover one or more through holes, recesses, or both. The one or more cap portions may function to prevent fluid from penetrating into the photovoltaic array. The one or more cap portions may be a final row of a photovoltaic array. The one or more cap portions may complete a final row, be a top layer of a row, a top layer of the photovoltaic array, or a combination thereof. The one or more cap portions may overlap one or more photovoltaic components. The one or more cap portions may be free of through holes, handles, connection recesses, fastener locations, alternative fastener locations, or a combination thereof. The one or more cap portions may be substantially solid. The one or more cap portions may include one or more connection hooks for forming a connection with an adjacent photovoltaic component. The one or more cap portions may include one or more alignment slots, alignment ribs, or both for alignment with the one or more adjacent photovoltaic components. The one or more cap portions may include one or more cap extensions that extend over a portion of a second row, an adjacent row, or both.

The one or more cap extensions may function to extend a cap portion from a first row to a second row. The one or more cap extensions may extend from a top row to a row below the top row. The one or more cap extensions may create a fluid barrier that covers a seam between two rows. The one or more cap extensions may be located below a plane of a cap portion. The one or more cap extensions may be located in the same plane as the cap portion. The one or more cap extensions may include any of the features of the cap portion and may perform any of the functions of the cap portions. The one or more cap portions, one or more cap extensions, or both may be free of an alignment rib, an alignment slot, or both.

The one or more alignment ribs may function to align one or more photovoltaic components relative to each other. The one or more alignment ribs may prevent one photovoltaic component from moving relative to another photovoltaic component. Preferably, the one or more alignment ribs extend from an upper surface of a photovoltaic component. More preferably, the one or more alignment ribs extend from an upper surface of a row to row connector portion. The one or more alignment ribs may be a linear piece that extends vertically above a top surface of a flashing component. The one or more alignment ribs may provide a feature that forms a complementary fit with one or more alignment slots of an adjacent photovoltaic component.

The one or more alignment slots may function to receive an alignment rib to align two photovoltaic components relative to each other. The one or more alignment slots may form a complementary fit with one or more alignment ribs. The one or more alignment slots may prevent movement of a photovoltaic component that includes an alignment rib when the alignment slot and alignment rib are in communication. Preferably, the shape of the alignment slots and the alignment ribs are complementary. The alignment slots may be located on a bottom side so that when a photovoltaic component extends over another photovoltaic component the alignment rib extends into the alignment slot. The one or more alignment slots may be located in a flashing piece when the flashing piece is a standard piece, a plus piece, a minus piece, or a combination thereof.

The one or more standard pieces may function to assist in collecting sunlight and creating power. The one or more standard pieces may be a standard size. The one or more standard pieces may be sized so that one piece may form a partial overlap of at least two pieces. The standard piece may have a length (X) and a width (Y). Length when discussed herein is the distance along the slope and width is the direction transverse to the length. The standard pieces may have a width that is less than the plus pieces and is greater than the minus pieces.

The plus pieces may function to fill a gap created by one or more pieces being offset. The plus pieces may function to fill a gap that is wider than a standard gap. The photovoltaic array may include one or more plus pieces. The photovoltaic array may include a plurality of plus pieces. One or more rows may include one or more plus pieces. The length of the plus piece may be the same as a standard piece and a minus piece (i.e., X). The photovoltaic components may have a standard length, a minus length, a plus length, or a combination thereof. The length of a plus length piece may be about 1.2X or more, about 1.5X or more, or even about 1.8X or more. The length of the plus length piece may be about 4X or less, about 3X or less, or about 2X or less. The plus length piece may function to extend fully or partially between two or more rows. The plus length piece may fully cover a minus length piece and fully or partially cover a standard length piece. The plus length piece may electrically connect two adjacent rows. The length of a minus length piece may be about 0.8X or less, about 0.7X or less, or about 0.5X or less. The length of a minus length piece may be about 0.3X or more, about 0.4X or more, or even about 0.45X or more. The minus length piece may function to only receive a portion of a length of a standard piece, or a plus length piece so that the standard piece, the plus length piece, or both covers all of the minus length piece and a portion of a piece in an adjacent row. The minus length piece may be a base piece. The plus pieces may have a greater length due to the addition of a row to row connector portion, a cap extension, a flashing extension, or a combination thereof. The length and width of the photovoltaic components may include the flashing interfaces, the flashing extensions, or both. Preferably, the length and the width of the photovoltaic components is the body portion. More preferably, the length and width of the photovoltaic components is measured without measuring the flashing interface, the flashing extension, or both.

The width of the plus piece may be greater than a standard piece. The width of a plus piece may be about 1.1Y or more, about 1.2Y or more, about 1.3Y or more, or even about 1.5Y or more. The width of a plus piece may be about 2Y or less, about 1.8Y or less, or even about 1.7Y or less than a standard piece. The width of a plus piece relative to a minus piece may be about 1.5Y or more, about 1.7 or more, or even about 1.8Y or more. The width of a plus piece relative to a minus piece may be about 2.5Y or less, about 2.3Y or less, or about 2Y or less. The plus piece may have a portion that extends between two adjacent rows. The plus piece may include one or more cap portions. The plus piece may be a corner flashing piece. The plus piece may be a row to row flashing piece. The plus piece may be a center flashing piece. Preferably, the plus pieces are corner flashing pieces. The plus pieces may assist in creating a step out, a step in, or both. The plus pieces may be located in the same row as a minus piece so that the offset of the pieces is compensated for and a square, rectangular, symmetrical, or a combination thereof photovoltaic array is created. A row may include an equal number of plus pieces as minus pieces.

The one or more minus pieces may function to fill in a gap created by one or more pieces being offset within a row. The one or more minus pieces may fill in a gap created by one or more plus pieces being installed. The photovoltaic array, a row, or both may include one or more minus pieces. The photovoltaic array, a row, or both may include a plurality of minus pieces. The one or more minus pieces relative to a standard piece may have a width that is about 0.5Y or more, about 0.6Y or more, about 0.7Y or more, or even about 0.75Y or more. The one or more minus pieces relative to a standard piece may have a width that is about Y, about 0.9Y or less, or about 0.8Y or less. The one or more minus pieces may assist in maintaining all of the rows the same length. The one or more minus pieces may assist in forming a photovoltaic array that is square, rectangular, symmetrical, or a combination thereof. The one or more minus pieces may preferably be a row to row flashing piece, a corner flashing piece, or a combination of both.

The one or more corner flashing pieces may function to terminate one or more rows. The one or more corner flashing pieces may be located in a corner of the photovoltaic array. The one or more corner flashing pieces may include at least two flashing interfaces. The flashing interfaces on a corner flashing piece may be at an angle relative to each other. The one or more corner flashing pieces may be a portion of a starter row, a portion of an ending row, or both. The one or more corner flashing pieces may not be located within internal rows. The one or more corner flashing pieces may be a top right, top left, bottom right, bottom left, minus piece, plus piece, standard piece, or a combination thereof.

The top right minus piece, top right plus piece, or both may function to form a portion of an ending row. The top right minus piece, top right plus piece, or both may function to cap a portion of a row. The top right minus piece, top right plus piece, or both may extend over a portion of a photovoltaic module, a portion of a row to row connector, or both. The top right minus piece, top right plus piece, or both may be free of through holes. The top right minus piece, top right plus piece, or both may include one or more and preferably a plurality of connection hooks. The top right minus piece, top right plus piece, or both may extend over a row to row connection portion, over an alignment rib, or both. The top right minus piece, top right plus piece, or both may extend in only one row. Preferably, when a top right plus piece is used on one edge a top left minus piece is used on the opposing edge. Correspondingly, when a top right minus piece is used on one edge a top left plus piece is used on the opposing edge.

The top left minus piece, top left plus piece, or both may function to form a portion of an ending row. The top left minus piece, top left plus piece, or both may function to cap a portion of a row. The top left minus piece, top left plus piece, or both may be a cap or a cap and cap extension. The top left minus piece, top left plus piece, or both may be free of through holes. The top left minus piece, top left plus piece, or both may include one or more and preferably a plurality of connection hooks. The top left minus piece may be used instead of a top left plus piece or vice versa. The top left minus piece, top left plus piece, or both may be located on opposite edges of the photovoltaic array as a top right minus piece, a top right plus piece, or both.

The bottom left plus piece, bottom left minus piece, bottom right plus piece, bottom right minus piece, or a combination thereof may function to terminate one or more rows. The bottom left plus piece, bottom left minus piece, bottom right plus piece, bottom right minus piece, or a combination thereof form a terminal piece. The bottom left plus piece, bottom left minus piece, bottom right plus piece, bottom right minus piece, or a combination thereof may be a base piece that begins a row, begins the photovoltaic array, or both. The bottom left plus piece, bottom left minus piece, bottom right plus piece, bottom right minus piece, or a combination thereof may be entirely directly connected to a support structure and the pieces in an adjacent row may overlap a portion and build off of the bottom left plus piece, bottom left minus piece, bottom right plus piece, bottom right minus piece, or a combination thereof. The bottom left plus piece, bottom left minus piece, bottom right plus piece, bottom right minus piece, or a combination thereof may be part of a starter row, may form opposing edges of a starter row, or both. When a bottom left plus piece is installed a bottom right minus piece may be installed. Conversely, when a bottom right plus piece is installed a bottom left minus piece may be installed. The bottom right pieces (plus or minus) may be located on opposite edges as the bottom left pieces (plus or minus). The bottom left plus piece, bottom left minus piece, bottom right plus piece, bottom right minus piece, or a combination thereof may be used in a row other than the starter row. The bottom left plus piece, bottom left minus piece, bottom right plus piece, bottom right minus piece, or a combination thereof may be in communication with a center flashing piece, also the top right plus piece, top right minus piece, top left plus piece, top left minus piece, or a combination thereof may be in communication with one or more center flashing pieces.

The one or more center flashing pieces may function to extend between edges of a photovoltaic array. The one or more center flashing pieces may provide support for one or more active components. The one or more center flashing pieces may cap one or more active components. The one or more center flashing pieces may be part of a starter row, an ending row, or both. The one or more center flashing pieces may connect to another center flashing pieces, a corner flashing piece, or both. The one or more center flashing pieces may include only connection hooks or only connection recesses. The one or more center flashing pieces may be a bottom piece, a top piece, or both.

The one or more bottom pieces may function to connect to a support structure. The one or more bottom pieces may function to extend between two corner pieces. The one or more bottom pieces may include a row of connection members. Preferably, the one or more bottom pieces may include a row of connection recesses (e.g., a plurality of connection recesses). The one or more bottom pieces may form an interface with standard shingles. The one or more bottom pieces may form the base for the entire photovoltaic array. The one or more bottom pieces may form a base connection structure. The one or more bottom pieces may be located opposite a top piece.

The one or more top pieces may function to cap the photovoltaic array. The one or more top pieces may function to cover one or more connection recesses, one or more handles, one or more through holes, or a combination thereof of one or more photovoltaic components. The one or more top pieces may include only connection hooks. The one or more top pieces may be free of contact with a row to row flashing piece.

The one or more row to row flashing pieces may extend between two or more rows. The one or more row to row flashing pieces may function to physically connect, electrically connect, or both two or more adjacent rows. The row to row flashing pieces may electrically connect a first row to a second row. The row to row flashing pieces may electrically connect two rows and cap a portion of one row while providing a support structure for a portion of another row. The row to row flashing pieces may include a cap portion, an overlap portion, or both. The row to row flashing pieces may be a corner piece as well as a row to row flashing piece. The row to row flashing pieces may include one or more flashing interfaces, one or more flashing walls, one or more flashing extensions, or a combination thereof. The row to row flashing pieces may include a plurality of connection members. The row to row flashing pieces may include connection hooks, connection recesses, or both. The row to row flashing pieces may include a row to row connection portion. The row to row connection portion may extend between a first row and a second row. A row to row connector portion may separate two portions of a row to row flashing piece. The row to row flashing pieces may be located on a right side, a left side, or both. The right side pieces may be a reverse mirror image to the left side pieces. The row to row flashing pieces may be a bottom left minus piece, a bottom left plus piece, a bottom right minus piece, a bottom right plus piece, or a combination thereof.

The bottom left minus piece, a bottom left plus piece, a bottom right minus piece, a bottom right plus piece, or a combination thereof may function to connect a bottom row to an adjacent row. The bottom left minus piece, a bottom left plus piece, a bottom right minus piece, a bottom right plus piece, or a combination thereof may extend over a corner flashing piece, a bottom flashing piece, or both. The bottom left minus piece, a bottom left plus piece, a bottom right minus piece, a bottom right plus piece, or a combination thereof may include a row to row connector portion that extends from the first row to a second row. For example, the row to row connector portion may extend from the starter row to the next adjacent row. The bottom left minus piece, a bottom left plus piece, a bottom right minus piece, a bottom right plus piece, or a combination thereof may form both a base part of the starter row and extend to an adjacent row. The bottom left minus piece, a bottom left plus piece, a bottom right minus piece, a bottom right plus piece, or a combination thereof may have the row to row connector portion on the right side (if a right piece) or the left side (if a left piece). The bottom left minus piece, a bottom left plus piece, a bottom right minus piece, a bottom right plus piece, or a combination thereof may form a connection with a standard shingle, an overlap with a shingle, or both. If a row has a bottom right piece (plus or minus) the row does not include a bottom left piece (plus or minus) or vice versa. For example, if a photovoltaic array includes a bottom right minus piece that connects the first row and the second row, then the left side does not have a bottom left minus piece and has a left piece that connects the second row to the third row. The bottom left minus piece, a bottom left plus piece, a bottom right minus piece, a bottom right plus piece, or a combination thereof preferably, have a cap portion, an overlap portion, or both on one side of a row to row connector portion. The bottom left minus piece, a bottom left plus piece, a bottom right minus piece, a bottom right plus piece, or a combination thereof may be free of a cap portion, an overlap portion, or both on both sides of the row to row connector portion.

The step in right pieces, step in left pieces, or both may function to create a non-square or non-rectangular photovoltaic array. The step in right pieces, step in left pieces, or both may function to shift to accommodate a roofing structure. The step in right pieces, step in left pieces, or both may terminate one row and extend a row. The step in right pieces, the step in left pieces, or both may be a row to row flashing piece, a corner piece, include a row to row component, include a corner component, or both. The step in right pieces, the step in left pieces, or both may include a row to row connector piece, connect two or more rows, or both. The step in right pieces, step in left pieces, or both may shift a row to one side. The step in right pieces, step in left pieces, or both may have a portion that extends over one row and may have an overlap portion that extends under another row. The step in right pieces, step in left pieces, or both may include connection hooks and connection recesses. The step in right pieces, step in left pieces, or both may be located opposite or be used in lieu of a left piece, a right piece, or both.

The one or more left pieces, one or more right pieces, or both may function to connect two or more internal rows. The one or more left pieces, one or more right pieces, or both may be located on edges of the photovoltaic array. The one or more left pieces, one or more right pieces, or both may connect a second row to a third row or a third row to fourth row. The one or more left pieces, one or more right pieces, or both may connect an internal row to an ending row. The one or more left pieces, one or more right pieces, or both may have a row to row connector portion that extends along the peripheral edge of the photovoltaic array. The one or more left pieces, one or more right pieces, or both may have a cap portion that extends over a photovoltaic component, an overlap portion that extends under a photovoltaic component, or a combination of both. The right piece and the left piece may be staggered from row to row so that the electrical circuitry extends in a serpentine manner. The one or more left pieces, one or more right pieces, or both may include one or more connector hooks, one or more connector recesses, or both. Preferably, the left piece, the right piece, or both include a row to row connector portion.

The row to row connector portion may function to electrically connect, physically connect, or both, two adjacent rows. The row to row connector portion may have two connector channels that connect two rows. The row to row connector portion may include one connector channel and the connector channel may be electrically connected to an adjacent connector channel so that power is transferred between two adjacent rows. The row to row connector portion may include one or more connection hooks, one or more connection recesses, or both. The row to row connector portions may be located proximate to one or more openings in the photovoltaic components.

The one or more openings may function to provide access to the photovoltaic components when the photovoltaic components are connected together. The one or more openings may function to create access to one or more conductors, one or more connector channels, or both. The one or more openings may assist in connecting two or more photovoltaic components. The one or more openings may include one or more sockets so that a door may close the opening.

The one or more sockets may function to connect a door to the photovoltaic module. The one or more sockets may allow for rotational movement of the door between an open and closed position. The one or more sockets may lock a door in place. The one or more sockets may receive a portion of the door, a projection of the door, or both so that a connection is formed. The one or more sockets may be located on an underside of the photovoltaic components. The one or more sockets may allow a door to be added and removed while the photovoltaic component is connected within the photovoltaic array.

The one or more doors may cover an opening. The one or more doors may function to prevent fluid from penetrating into an opening. The one or more doors may function to prevent fluid from moving in the opposite direction as the slope of the roof and penetrating the photovoltaic array. The one or more doors may include one or more projections that connect the door within the photovoltaic device.

The one or more projections may function to connect a door within a socket, an opening, or both. The one or more projections may function to form a connection with a socket. The one or more projections may extend into a socket. The one or more projections may allow for a door to be removed from an opening a photovoltaic component, or both. The one or more openings, one or more doors, one or, both may assist in blind connecting two or more components together.

The one or more alignment features may function to align two or more photovoltaic components so that the two or more photovoltaic components may be connected.

Preferably, the one or more alignment features function to align two or more connection members. More preferably, the one or more alignment features function to align one or more connection hooks with one or more connection recesses. Most preferably, the one or more alignment features function to align a plurality of connection hooks with a plurality of connection recesses during blind installation and assist in locking the plurality of connection hooks within the plurality of connection recesses. The alignment features may indicate a locked position, an unlocked position, or both. The alignment feature may function to horizontally (e.g., in a transverse direction to the slope of the support structure) align two or more photovoltaic components relative to one photovoltaic component. The alignment feature may function to vertically align two or more photovoltaic components. The alignment features may facilitate removal of one or more photovoltaic components from another photovoltaic component. The alignment features may function to connect two or more photovoltaic components of varying shape, size, dimensions, or a combination thereof. For example, one piece may be a standard piece and one piece may be a plus piece or a minus piece and the alignment features may align them relative to a photovoltaic component. The one or more alignment features may be located on a top surface of a photovoltaic component. The one or more alignment features may be located on a side, an edge, a top edge, a bottom edge, a side edge, may wrap from a top surface to an edge surface, or a combination thereof. The one or more alignment features may be located in a central portion, an edge region, or both of the top surface, an edge, a side, or a combination thereof. The one or more alignment features may be located in opposing edge regions. The one or more alignment features may be a marking on the surface of the photovoltaic components. The one or more alignment features may be a structure that is integral to the photovoltaic component. The one or more alignment features may be a series of shapes, series of lines, recesses, bumps, indentations, raised surfaces, or a combination thereof. The one or more alignment features may be made of a different material. The one or more alignment features may be tactically different than surrounding regions so that a user can feel an edge of an alignment feature, upon sliding a photovoltaic component to the alignment features a change in friction is felt, or both. The alignment features may be a visual indicator. The one or more alignment features may be used to align one photovoltaic component, two photovoltaic components, or both. The one or more alignment features may align with alignment features of adjacent photovoltaic components. The one or more alignment features may align with edges of an adjacent photovoltaic component. For example, in an unlocked position, locked position, or both the alignment feature may align with a bottom edge, a top edge or both to indicate an unlocked position or a locked position. The one or more alignment features may be a horizontal alignment feature, a vertical alignment feature, or both. The horizontal alignment feature and the vertical alignment features may be part of a single alignment feature, discrete from each other, located proximate to each other, or a combination thereof.

The one or more horizontal alignment features may function to horizontally align one or more photovoltaic components relative to one or more other photovoltaic components. The one or more horizontal alignment features may horizontally align connection members in a blind installation. For example, an alignment of one photovoltaic component (or its alignment features) relative to alignment features of a second photovoltaic component may result in the connection members being aligned so that visible recognition of the connection members is not needed for alignment. The one or more horizontal alignment features may horizontally align two or more photovoltaic devices relative to each other so that the connection members align during a blind installation. For example, if a first lower photovoltaic component (e.g., photovoltaic module) includes four connection recesses and a second lower photovoltaic component includes two connection recesses (e.g., a right piece), the one or more horizontal alignment features may align a third top photovoltaic component so that the third top photovoltaic component partially overlaps both the first and second lower photovoltaic components so that two connection hooks extend into each of the lower photovoltaic components forming a connection. The horizontal alignment features may assist in creating a proper overlap, proper offset, or both between photovoltaic components. The horizontal alignment features may be a vertical line, a vertical marking, or both. The horizontal alignment feature may indicate where a side edge is located relative to the photovoltaic component. The horizontal alignment feature may be located in a central region of the photovoltaic component. The horizontal alignment feature may bisect a photovoltaic component along its height so that two equally sized pieces are formed on each side of the horizontal alignment feature. The horizontal alignment feature may be located on a bottom piece, a bottom right plus piece, a bottom left plus piece, a photovoltaic module, or a combination thereof. The horizontal alignment feature may contact one or more vertical alignment features, may be located proximate to one or more vertical alignment features, or both.

The one or more vertical alignment features may function to vertically align two or more connection members. The one or more vertical alignment features may function to vertically align two connection members relative to each other during a blind connection. The one or more vertical alignment features may function to indicate an unlocked position, a locked position, or both. The one or more vertical alignment features of a first photovoltaic component may align with vertical alignment features of a second photovoltaic component. The one or more vertical alignment features of a first photovoltaic component may be moved between two vertical alignment features of a second photovoltaic component and as the vertical alignment feature is moved between the first vertical alignment feature and the second vertical alignment feature or vice versa the connection members may be located together or unlocked. The vertical alignment feature may be aligned with one or more common features of an adjacent photovoltaic component. For example, the vertical alignment feature may be aligned with a top edge, a bottom edge, or both of an adjacent photovoltaic component. The vertical alignment feature may be located in a central region, an edge region, along a side, along an edge, extend from a top surface to an edge, or a combination thereof. Preferably, the vertical alignment features are located on a top surface in either a central region or one or both edge regions. The vertical alignment features may be horizontal features (e.g., extend in the transverse direction relative to the slope of the roof. The vertical alignment features may extend the full width of the photovoltaic component. The vertical alignment features may extend a portion of the width (e.g., 20 percent or less, 10 percent or less, or even 5 percent or less of the total width) of the photovoltaic component. The vertical alignment features may be free of additional markings or indications. The vertical alignment features may be located on a top right plus piece, a top right minus piece, a bottom piece, a bottom right plus piece, a bottom left plus piece, a left piece, a top piece, a top left minus piece, a top left plus piece, a step in right piece, a step in left piece, a right piece, a photovoltaic module, or a combination thereof. The one or more alignment features may include a cut indicator.

The one or more cut indicators may function to indicate a location of a cut of a photovoltaic component. The one or more cut indicators may indicate a location of alignment for one or more adjacent photovoltaic components. The one or more cut indicators may be a vertical alignment feature, a horizontal alignment feature, or both. The one or more cut indicators may be located in the edge regions. The one or more cut indicators may run a length, a width, or both of the photovoltaic component. The one or more cut indicators may be located only in flashing components. The one or more cut indicators may align with one or more adjacent alignment features, one or more edges, or both. The one or more cut indicators may align a row to row component. The one or more cut indicators may be removed when a photovoltaic component is cut so that the edge of the photovoltaic component abuts an adjacent photovoltaic component.

A photovoltaic array may be formed by a method. The method may perform one or more of the following steps in virtually any order. The photovoltaic array may be entirely completed before any standard roofing components (e.g., roof shingles) are added to the roof. The photovoltaic array may be added after a majority of the standard roofing components are added to the roof. Preferably, at least some of the flashing components are added to the roof and then the roofing components are added around the flashing components, photovoltaic components, or both. Creating a starter row. Aligning the photovoltaic components in the starter row relative to each other. Connecting the starter row to a support structure. Creating a row that at least partially covers the starter row. Aligning a photovoltaic component over one or more and preferably two or more components of the starter row. Aligning one or both edges of the overlapping photovoltaic component with a horizontal alignment feature. Aligning a vertical alignment feature with a vertical alignment feature of one or both of the photovoltaic components in the starter row. Connecting the overlapping photovoltaic component with the one or more photovoltaic components of the starter row. Extending a connection hook into a connection recess with only using the alignment features. Moving the overlapping photovoltaic component so that a second alignment, a top edge, or some other feature aligns with the vertical alignment feature. Locking the overlapping photovoltaic component in place by vertically moving the overlapping photovoltaic component relative to the starter row. Fastening the overlapping photovoltaic component to the support structure. Continuing to align photovoltaic components along the starter row until a complete row is formed. Forming another row (e.g., third row) above the row overlapping (e.g., second row) the starter row (e.g., the first row). Repeating until a photovoltaic array of a sufficient size and shape is created. Placing a final row over the second to last row of photovoltaic components. Capping the photovoltaic components with a final row so that a water tight structure is created. A final row component may be horizontally aligned, vertically aligned, or both over the top row of photovoltaic components. The connection may be formed while the connection members are concealed from view. A blind connection may be formed between two or more connection members.

FIG. 1 illustrates a perspective view of a photovoltaic array 2 including a plurality of photovoltaic components 3. The photovoltaic array 2 includes three rows 4 of active components 20 with flashing components 60 located around the active components 20. As illustrated, the active components 20 are photovoltaic modules 21. The photovoltaic array 2 includes a peripheral edge 6 that forms an outer edge of the photovoltaic array 2. The photovoltaic array 2 includes a starter row 17 and an ending row 19 with a plurality of internal rows 18 extending therebetween. The starter row 17 is the first row formed and then the remaining rows are built off of the starter row 17.

FIG. 2 illustrates a cross sectional view of the photovoltaic array 2 of FIG. 1. The photovoltaic array 2 has a plurality of connecting members 10 that connect the active components 20 and the flashing components 60 together, the active components 20 to other active components 20, flashing components 60 to other flashing components 60, and a combination thereof. The connecting members 10 are located inside of a peripheral edge 6 of both the photovoltaic array 2 and each of the active components 20 and the flashing components 60. The connecting members 10 include both connection hooks 12 and connection recesses 14. The connection recesses 14 include a wall 16 that extends around each of the connection recesses 14. The active component 20 as shown includes an active portion 22 and an overlap portion 24. The active component 20 also includes a base plate 26 and a photovoltaic laminate 28 that generates power. The middle active component 20 is illustrated with the photovoltaic laminate 28 removed from the base plate 26.

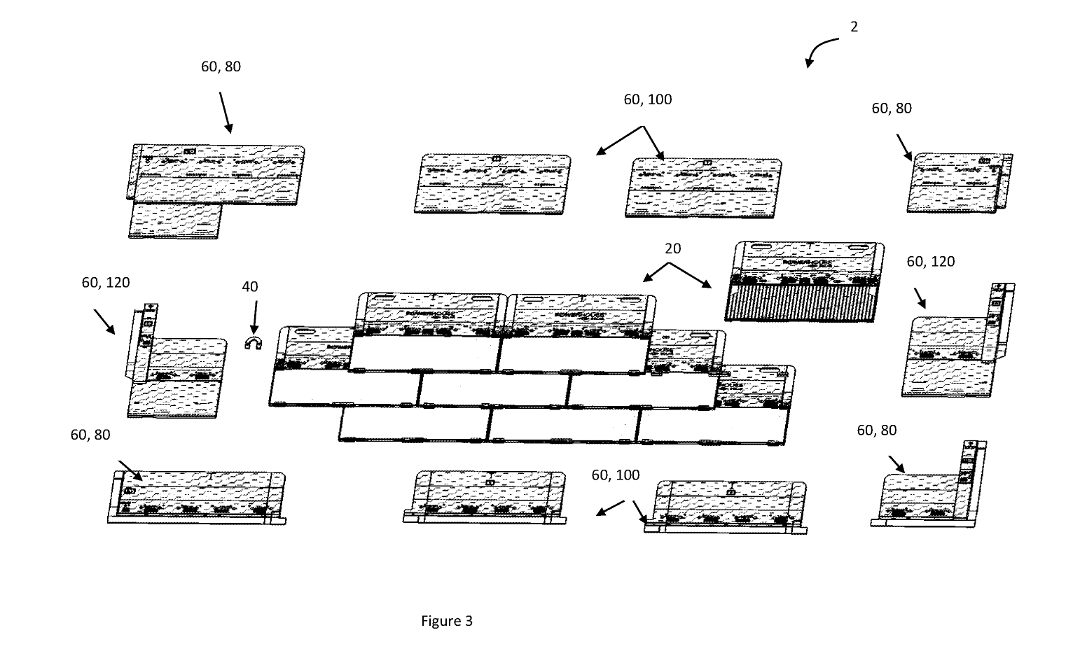

FIG. 3 illustrates an exploded view of the photovoltaic array 2. The photovoltaic array includes a plurality of active components 20 (e.g., photovoltaic modules) and a plurality of flashing components 60. The flashing components include corner flashing pieces 80, center flashing pieces 100, row to row flashing pieces 120, and a door 140 (not shown). One connector 40 is shown that interconnects (e.g., electrically and physically) the components together.

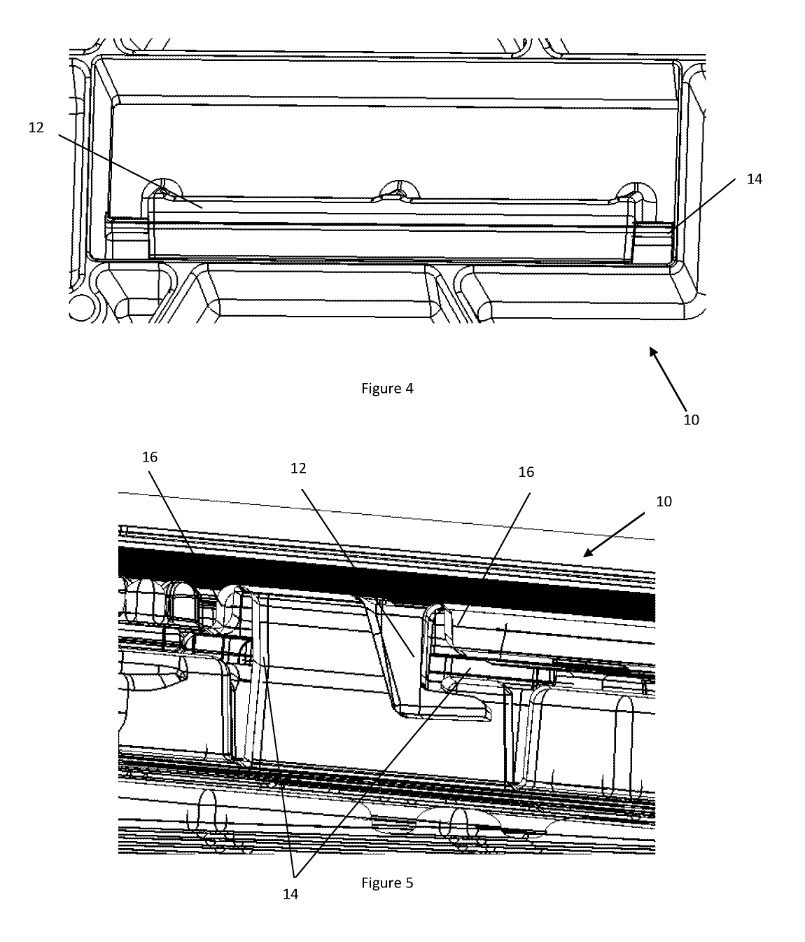

FIG. 4 illustrates a close-up view of a connection member 10 with the connection hook 12 extending through the connection recess 14 and hooking around to form a connection with the connection recess 14. The connection hook 12 contacts the connection recess 14 to prevent removal of an upper component from a lower component and to prevent wind uplift. The connection hook 12 and the connection recess 14 are both located inside of a peripheral edge of the photovoltaic components.

FIG. 5 illustrates a close-up view of the cross-sectional view of FIG. 2. As shown the connection members 10 are mated. The connection hook 12 is extended through the connection recess 14 and is in contact with the connection recess 14. A wall 16 extends around the connection recess 14 and the connection hook 12 that prevents fluids from penetrating to the next level of the photovoltaic array. The wall 16 of the connection recess 14 and the wall of the connection hook 12 form a complementary fit so that a tortuous path is created and fluid is prevented from penetrating through the connection recess 14.

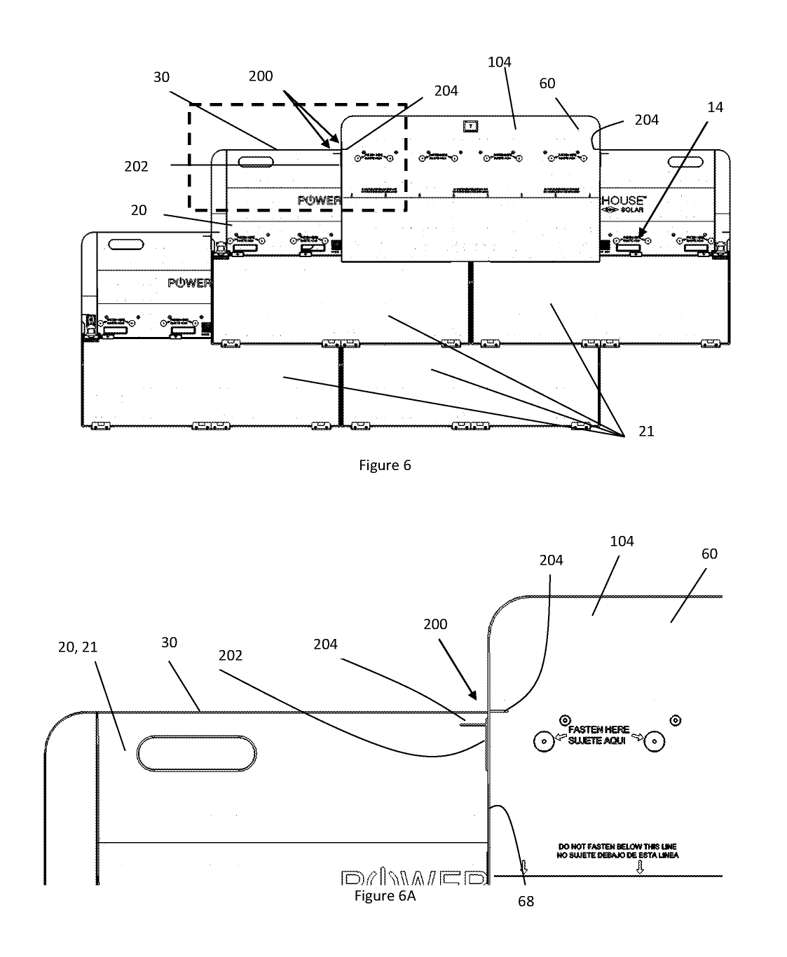

FIG. 6 illustrates a flashing component 60 extending over a pair of adjacent active components 20 that are overlapping another pair of adjacent active components 20, the active components 20 are photovoltaic modules 21. The flashing component 60 as shown is a top piece 104. The flashing component 60 and the active components 20 each include alignment features 200. The alignment features 200 on the flashing component 60 is a vertical alignment feature 204 that are located on each edge of the flashing component 60. The alignment feature 200 on the active component 20 is located substantially in the center of the active component 20. The alignment feature 200 includes both a horizontal alignment feature 202 and a vertical alignment feature 204. The horizontal alignment feature 202 indicates where an edge of the flashing component 60 aligns on the active component 20 so that a second flashing component 60 can be placed on the other half of the active component 20. During formation of a connection, the vertical alignment features 204 on the active component 20 and the flashing component 60 are aligned so that the connection hook (not shown) aligns with the connection recess 14. Once the connection hook is located within the connection recess, the flashing component is moved so that the vertical alignment feature 204 moves from being aligned with the vertical alignment feature 204 of the active component to a top edge 30 of the active component so that the connection hook is in communication with the connection recess.

FIG. 6A illustrates a close-up view of alignment features 200 that assist in forming a connection between the active component 20 (shown as a photovoltaic module 21) and the flashing component 60 (shown as a top piece 104). The alignment feature 200 has a horizontal alignment feature 202 for aligning a side edge 68 of the flashing component 60 on the active component 20. The alignment feature 200 of the active component 20 includes a vertical alignment feature 204 and the flashing component 60 includes a vertical alignment feature 204. The two vertical alignment features 204 are aligned so that the connection hook (not shown) and the connection recess (not shown) align and the connection hook can extend into the connection recess. Once the connection hook is extended into the connection recess the flashing component 60 is moved so that the vertical alignment feature 204 aligns with the top edge 30 of the active component 20 to a locked configuration. When the two vertical alignment features 204 are aligned the connection hook and the connection recess are in the unlocked configuration.

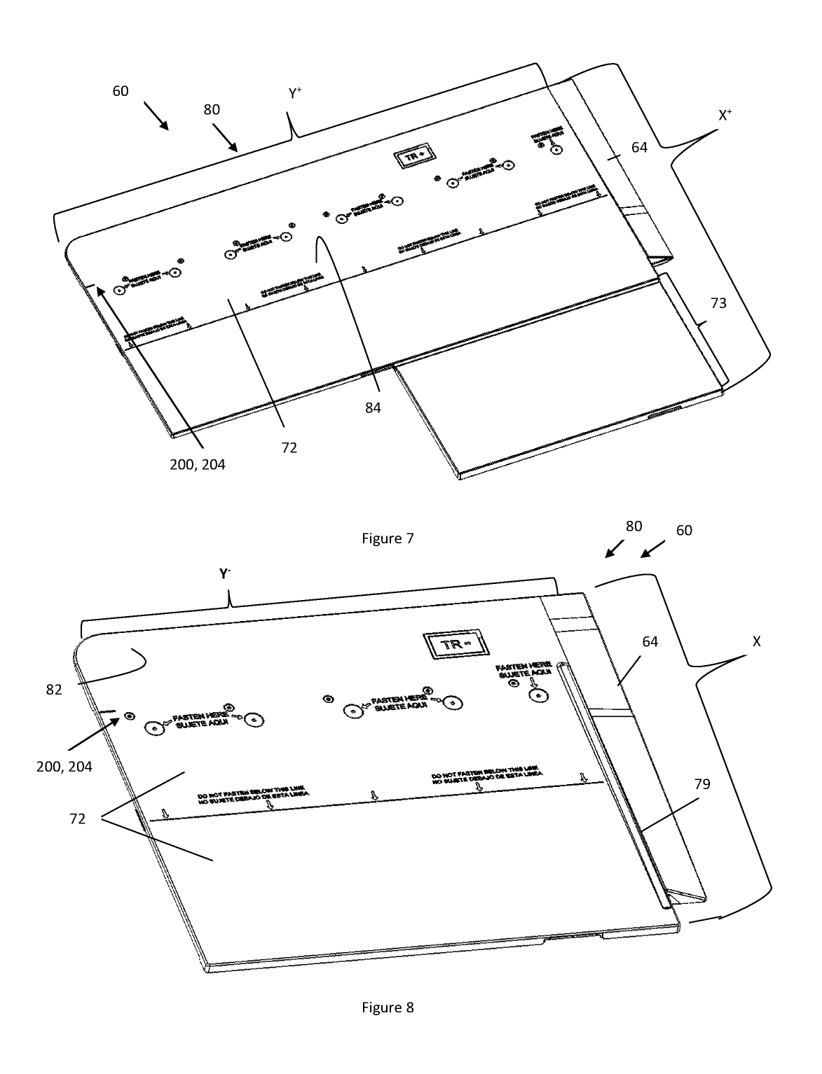

FIG. 7 illustrates a flashing component 60 that is a corner flashing piece 80. The corner flashing piece 80 is configured as a top right plus piece 84 that has a cap portion 72 that extends over an adjacent photovoltaic component (not shown) and the cap portion 72 has a side ledge 64 that moves fluid away from the photovoltaic array (shown in FIG. 1). The flashing component 60 includes a cap extension 73 that extends from the cap 72 over an adjacent flashing component (not shown) so that a shingle effect is created. An alignment feature 200 is located on an opposite edge as the side ledge 64. The alignment feature 200 is a vertical alignment feature 204. The top right plus piece 84 includes a flashing extension 73 that creates a plus length so that the length is (X+) (e.g., 1.2X or more) and the width has a plus width (Y+) (e.g., 1.2Y or more).

FIG. 8 illustrates a flashing component 60 that is a corner flashing piece 80. The corner flashing piece 80 is a top right minus piece 82. The top right minus piece 82 includes a cap portion 72 that extends over an adjacent photovoltaic component (not shown) and a side ledge 64 that guides fluids from the cap portion 72 off of the top right minus piece 82. An alignment slot 79 has a raised portion on a top surface of the top right minus piece 82 to assist in receiving an alignment rib (not shown). The top right minus piece 82 includes an alignment feature 200 on one edge that is a vertical alignment feature 204. The top right minus piece 82 has a length that is (X) and a width that is minus length (Y−) (e.g., 0.8Y or less).

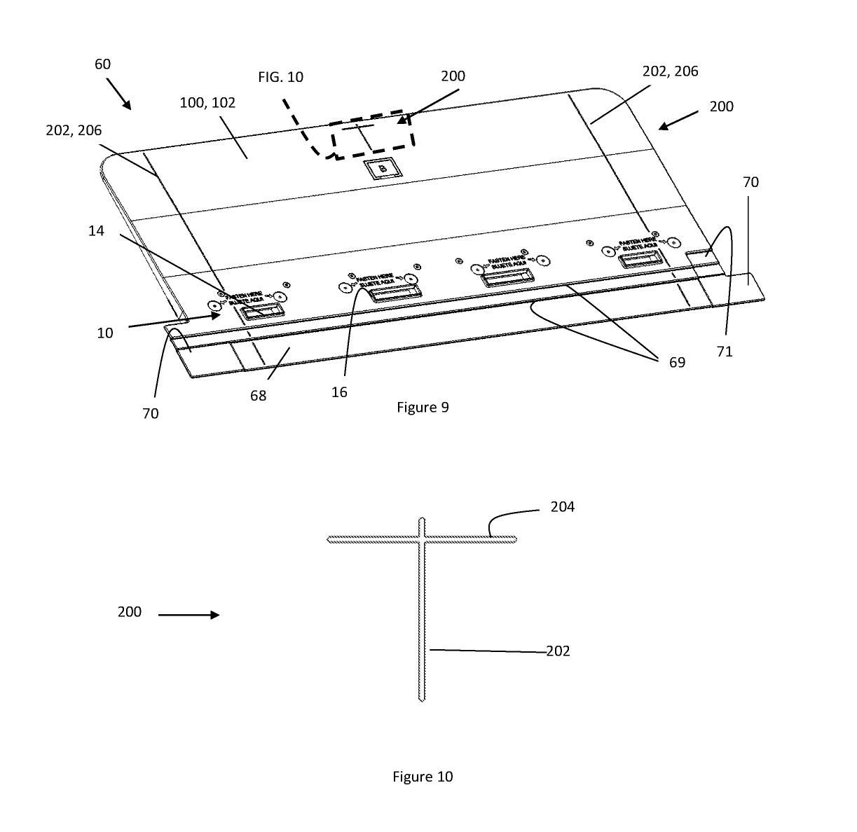

FIG. 9 illustrates a top perspective view of a flashing component 60 that is a center flashing piece 100. The center flashing piece 100 is a bottom piece 102. The bottom piece 102 includes a flashing interface 68 that extends over an adjacent photovoltaic component or a shingle (e.g., an asphalt shingle). The flashing interface 68 has a double flashing wall 69 that prevents fluid from going unto the photovoltaic array. Each end of the flashing interface 68 has a flashing extension 70. One of the flashing extensions 70 (e.g., a male flashing extension) is configured to extend over a flashing extension 70 with a pocket 71 (e.g., female flashing extension) and the other flashing extension 70 includes a pocket 71 that extends under and receives a flashing extension 70. Adjacent to the flashing interface 68 is a row of connection members 10. As shown the plurality of connection members 10 are connection recesses 14. Each of the individual connection recesses 14 include a wall 16 that extends around the connection recess and prevents fluid from entering the connection recess 14. An alignment feature 200 is located in central region of the bottom piece 102. The edges of the bottom left plus piece 86 also include cut indicators 206 that are alignment features 200 and serve as horizontal alignment features 202.

FIG. 10 illustrates a close up view of the alignment feature 200 of FIG. 9. The alignment feature 200 includes a horizontal alignment feature 202 and a vertical alignment feature 204. The horizontal alignment feature 202 aligns with a vertical side edge so that an adjacent photovoltaic component is aligned in the central region. The vertical alignment feature 204 aligns with either a part of a photovoltaic component such as an edge (not shown) or an alignment feature on the photovoltaic component (not shown) so that connection members are aligned and can be connected together.

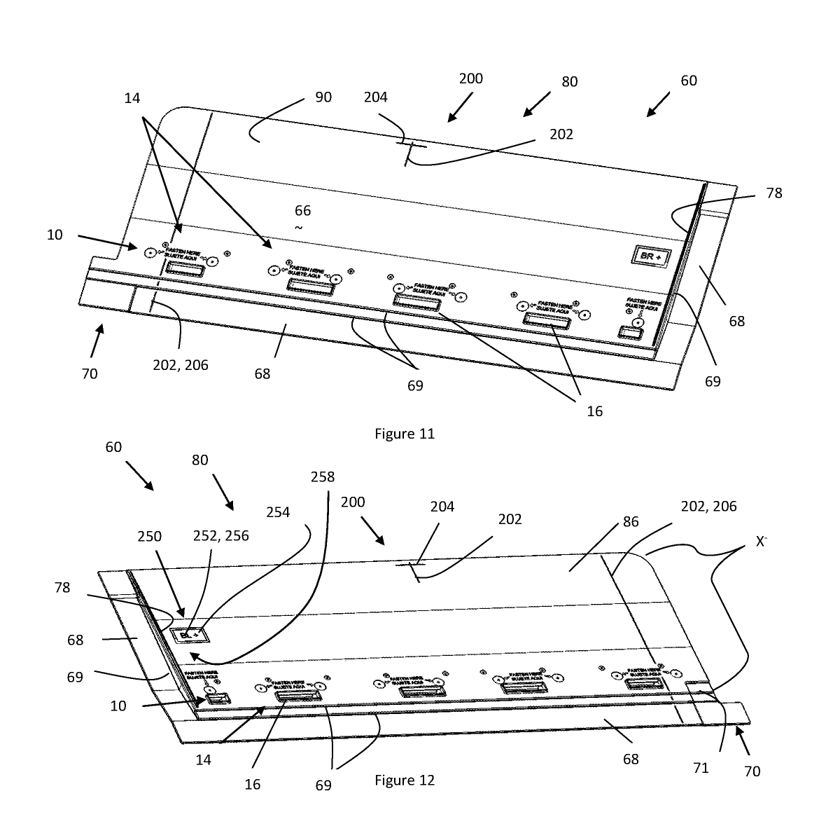

FIG. 11 illustrates a flashing component 60 that is a corner flashing piece 80 and is a bottom right plus piece 90. The bottom right plus piece 90 includes a flashing interface 68 that extends along two edges and includes a flashing wall 69 along both edges that prevent fluid from entering onto the photovoltaic array (not shown). An alignment rib 78 extends along a portion of the flashing walls 69 to further prevent fluid from entering the photovoltaic array (not shown) and for forming a connection with an adjacent photovoltaic component (not shown). The flashing interface 68 extends over and/or under shingles or one or more adjacent photovoltaic components. The flashing interface 68 also includes a flashing extension 70 that extends laterally beyond the overlap portion 66. The overlap portion 66 receives a photovoltaic component and includes a row of connection members 10. The connection members 10 as shown are connection recesses 14 that include a wall 16 about each of the connection recesses 14 for preventing fluid penetration into the connection recesses 14. The bottom right plus piece 90 includes a cut indicator 206 that is also a horizontal alignment feature 202.

FIG. 12 illustrates a top perspective view of a flashing component 60 that is a corner flashing piece 80. The corner flashing piece 80 is a bottom left plus piece 86 and includes a row of connection members 10 that are configured as connection recesses 14 that extend through the bottom left plus piece 86, and each connection recess 14 includes a wall 16 that extends around each of the connection recesses 14. A flashing interface 68 extends along two edges of the corner flashing piece 80 so that the flashing interface 68 can extend under roofing shingles or one or more adjacent photovoltaic components along a vertical side edge and over roofing shingles or one or more adjacent photovoltaic components along a bottom edge. Two flashing walls 69 on one side and one flashing wall 69 on a second side prevent fluid from moving from the roofing member (not shown) unto the bottom left plus piece 86. An alignment rib 78 extends along a portion of the flashing wall 69 so that the alignment rib 78 alignments with an alignment slot 79 (not shown) in an adjacent photovoltaic component (not shown). The flashing interface 68 includes a flashing extension 70 that includes a pocket 71 which extends under an adjacent photovoltaic component (not shown). The bottom left plus piece 86 includes an alignment feature 200 that includes a horizontal alignment feature 202 and a vertical alignment feature 204. The horizontal alignment feature 202 and the vertical alignment feature 204 intersect. The alignment feature 200 is also a cut indicator 206 that serves as a horizontal alignment feature 202. The alignment feature 200 is located on the face of the flashing component generally adjacent to an installation indicator 250. The installation indicator 250 includes characters 252 that as shown are letters 256 indicating the position of the flashing component 60 in a verbal form (or active component). The installation indicator 250 includes a symbol 254 that describes the width of the flashing component 60 (as well as active components). The installation indicator 250 includes highlights 258 that graphically depicts the location for installation of the flashing component (or active component). The left plus piece 86 illustrates a length minus piece that has a length (X⁻).

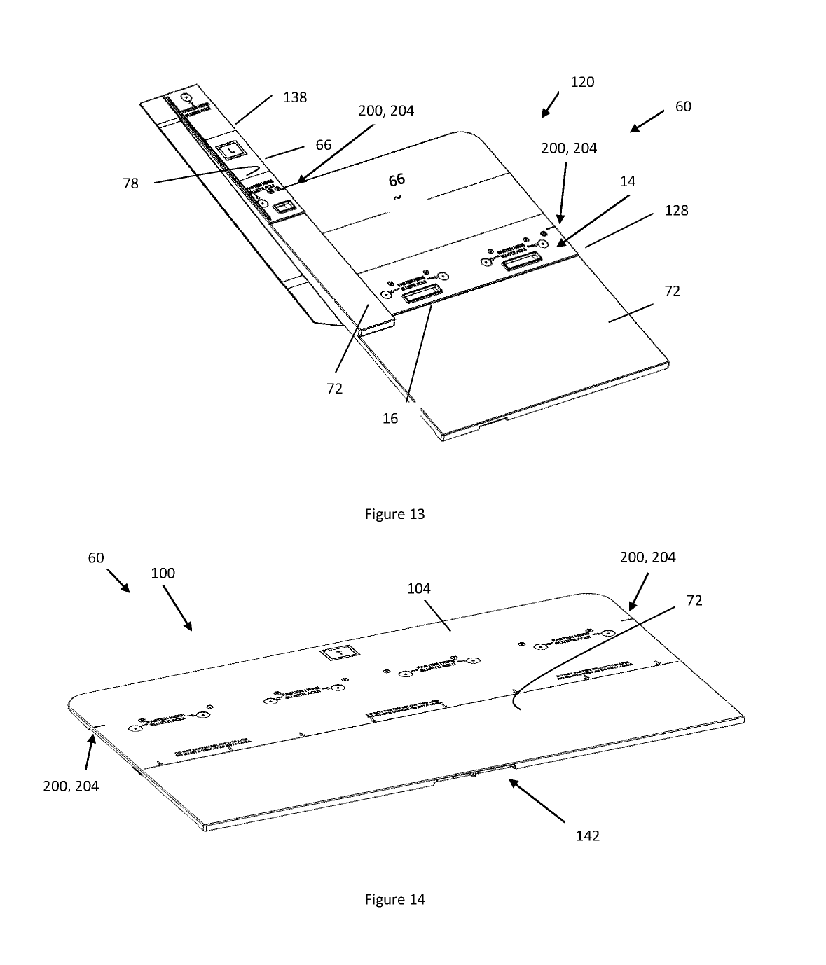

FIG. 13 illustrates a flashing piece 60 that is a row to row flashing piece 120. The row to row flashing piece 120 is a left piece 128. The left piece 128 includes a row to row connector portion 138 that connects two adjacent rows together. The row to row connector portion 138 is connected to and includes both an overlap portion 66, a cap portion 72, and an alignment rib 78. The left piece connects two full rows together but extends between three rows. An overlap portion 66 of the row to row connector portion 138 extends under a first piece of a first row, the cap 72 of the row to row connection portion 138 and the overlap portion 66 are aligned in a second row, and the cap 72 connected to the overlap portion 66 extends over a piece in a third row. The row to row connection portion 138 includes an alignment feature 200 that is a vertical alignment feature 204. Connection recesses 14 extend through the left piece 128 for forming a connection with one or more adjacent components (not shown). Each of the connection recesses 14 are surrounded by a wall 16 that assists in preventing fluid from entering the connection recess 14. The left piece 128 includes an alignment feature 200 that is a vertical alignment feature 204. Another vertical alignment feature 204 is located on the row to row connector portion 138.

FIG. 14 illustrates a top perspective view of a flashing component 60 that is a center flashing piece 100 and is a top piece 104. The top piece 104 is a cap piece 72 that covers one or more adjacent photovoltaic components so that fluid flows down the photovoltaic array. The top piece 104 includes an opening 142 for exposing a portion of an adjacent photovoltaic component that can be covered by a door (not shown). An alignment feature 200 is located on both edges of the top piece 104 and the alignment features 200 are vertical alignment features 204.

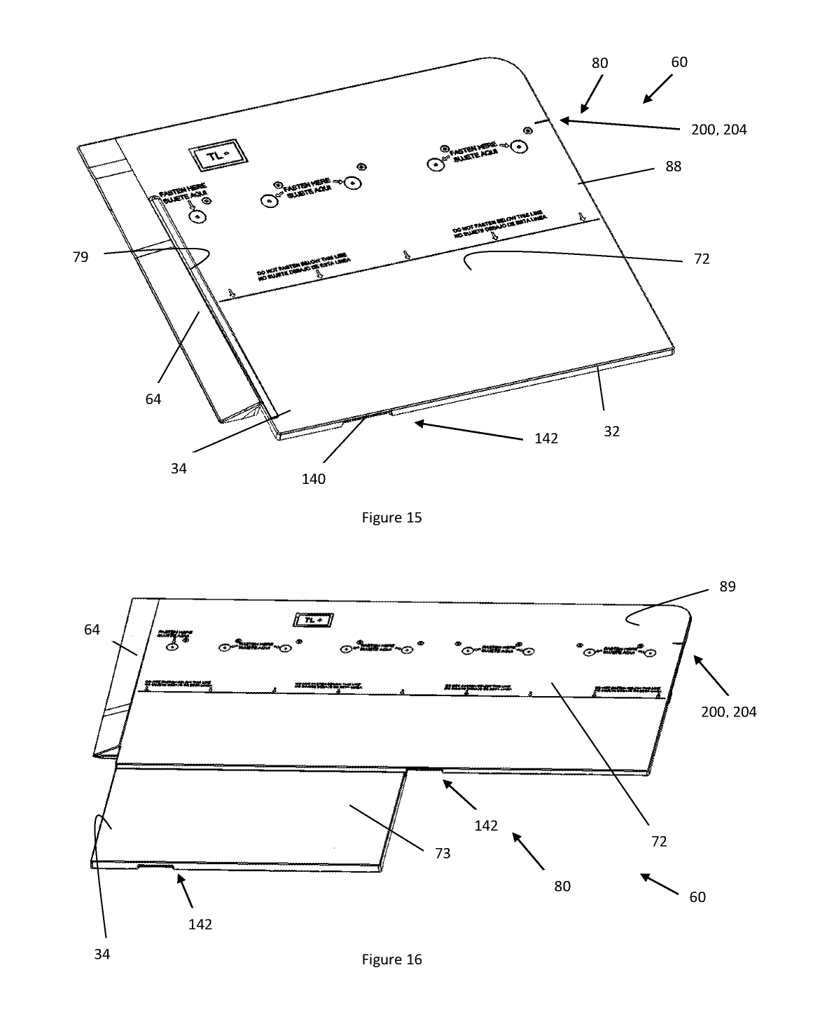

FIG. 15 illustrates a flashing component 60 that is a corner flashing piece 80. The corner flashing piece 80 is a top left minus piece 88 that is a cap portion 72 and extends over an adjacent photovoltaic component (not shown) forming a shingled section with no through holes for fluids to pass through. The top left minus piece 88 includes a side edge 34 with a side ledge 64 extending therefrom for forming an overlap with adjacent photovoltaic components or a shingle and for preventing fluid from extending onto the top left minus piece 88. A raised portion of an alignment slot 79 is located proximate to and extends along the side edge 34 and side ledge 64. A bottom edge 32 includes an opening 142 that is covered by a door 140. The top left minus piece 88 includes an alignment feature 200 that is a vertical alignment feature 204 in an edge region.

FIG. 16 illustrates a flashing component 60 that is a corner flashing piece 80. The corner flashing piece 80 is a top left plus piece 89. The top left plus piece 89 includes a cap portion 72 that extends over one or more photovoltaic components in a photovoltaic array (not shown). The cap portion 72 includes a side ledge 64 that forms a terminal edge. A cap extension 73 extends from the cap portion 72 an includes a side edge 34 that is free of a side ledge so that another component (not shown) that includes a side ledge can extend next to an under the cap extension 73. Both the cap extension 73 and the cap portion 72 include openings 142 that can be covered by a door (not shown), the openings are for exposing a component (not shown) that is covered by the cap extension 73. The top left plus piece 89 includes an alignment feature 200 that is a vertical alignment feature 204 in an edge region.

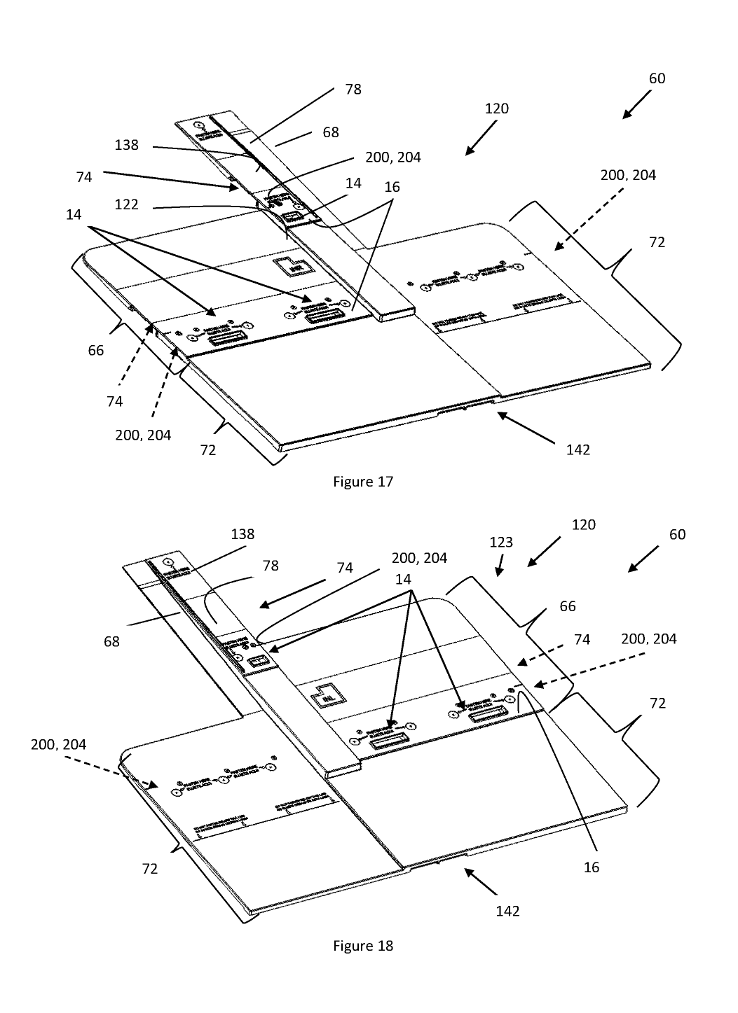

FIG. 17 illustrates a top perspective view of a flashing component 60 that is a row to row flashing piece 120. The row to row flashing piece 120 is a step in right piece 122. The step in right piece 122 includes two halves that are separated by a row to row connector portion 138 that includes a flashing interface 68 along one side and a connector channel 74 along an opposing side and an alignment rib 78 extending through a central portion. On a first side (e.g., right as shown) of the row to row connector portion 138 there is a cap portion 72 that extends over and covers one or more adjacent photovoltaic components so that fluid is prevented from extending through the photovoltaic components and a shingle effect is created. On the second side (e.g., left side as shown) of the row to row connector portion 138 there is partial cap portion 72 and overlap portion 66. The cap portion 72 includes an opening 142 that exposes an internal location of the step in right piece 122 and may be closed by a door (not shown). The overlap portion 66 includes connection recesses 14 that are each surrounded by walls 16. An edge of the overlap portion 66 includes an opening for a connector channel 74 so that an electrical connection can be formed. The step in right piece 122 includes alignment features 200 on opposing edge regions and on the row to row connector portion 138. The alignment features 200 vertical alignment features 204 for aligning other photovoltaic components relative to the step in right piece 122.

FIG. 18 illustrates a top perspective view of a flashing component 60 that is a row to row flashing piece 120. The row to row flashing piece 120 is a step in left piece 123. The step in left piece 123 includes two halves that are separated by a row to row connector portion 138 that includes a flashing interface 68 along one side and a connector channel 74 along an opposing side and an alignment rib 78 and connection recess 14 extending through a central portion. On a first side (e.g., left as shown) of the row to row connector portion 138 there is a cap portion 72 that extends over and covers one or more adjacent photovoltaic components so that fluid is prevented from extending through the photovoltaic components and a shingle effect is created. On the second side (e.g., right side as shown) of the row to row connector portion 138 there is partial cap portion 72 and overlap portion 66. The cap portion 72 includes an opening 142 that exposes an internal location of the step in right piece 122 and may be closed by a door (not shown). The overlap portion 66 includes connection recesses 14 that are each surrounded by walls 16. An edge of the overlap portion 66 includes an opening for a connector channel 74 so that an electrical connection can be formed. The step in left piece 123 includes alignment features 200 on opposing edge regions and on the row to row connector portion 138. The alignment features 200 vertical alignment features 204 for aligning other photovoltaic components relative to the step in left piece 123. The step in left piece 123 is a mirror image of the step in right piece 122 of FIG. 17.

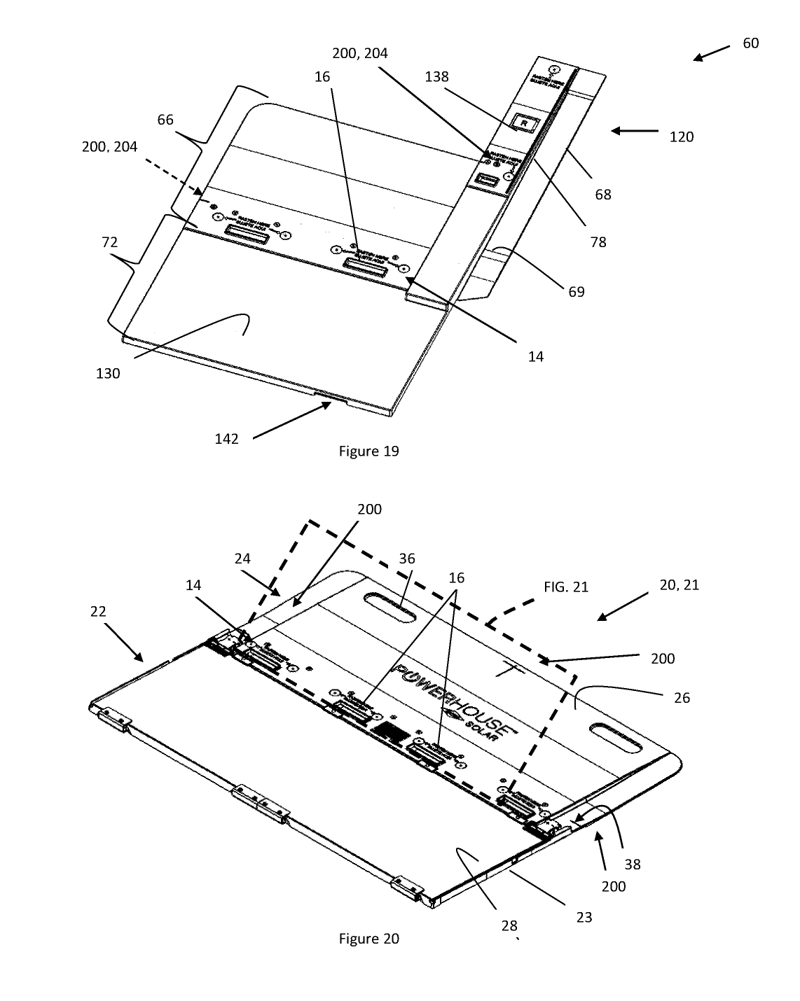

FIG. 19 illustrates a top perspective view of a flashing component 60 that is a row to row flashing piece 120. The row to row flashing piece 120 is a right piece 130. The right piece 130 includes a row to row connector portion 138 having a flashing interface 68 and a flashing wall 69 proximate to the flashing interface 68, and an alignment rib 78 extending along the row to row connector portion 138. The row to row connector portion 138 is connected to an overlap portion 66 and a cap portion 72. The overlap portion 66 includes connection recesses 14 that are surrounded by walls 16 so that fluid is preventing from flowing into the connection recesses 14. The cap portion 72 is located below the overlap portion 66 and the cap portion 66 includes an opening 142 along an edge that may be covered by a door (not shown). An alignment feature 200 is located opposite the row to row connector portion 138 and the alignment feature 200 is a vertical alignment feature 204.

FIG. 20 illustrates a top perspective view of an active component 20 that is a photovoltaic module 21. The photovoltaic module 21 includes an active portion 22 and an overlap portion 24. The active portion 22 includes a photovoltaic laminate 28 that generates power and the overlap portion 24 includes connection recesses 14 for forming a connection with an adjacent photovoltaic component (not shown). The photovoltaic laminate 28 is located on a support portion 23 that provides support to the photovoltaic laminate 28. The overlap portion 24 includes handles 36 for carrying the photovoltaic module 21 and connector channels 38 that assist in forming a connection with a connector (not shown). Each of the connection recesses 14 include a wall 16 that extends around a periphery of the connection recess 14. The photovoltaic laminate 28 sits on top of a base plate 26. The photovoltaic module 21 includes alignment features 200 in a central region and in opposing edge regions.

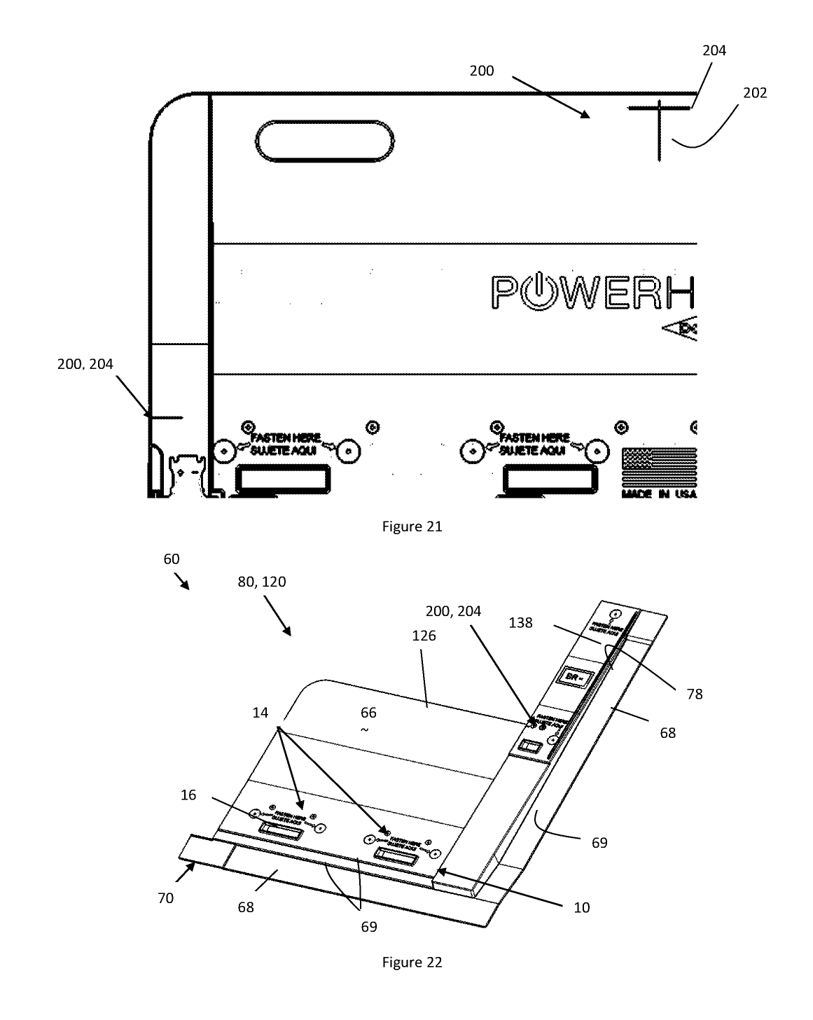

FIG. 21 illustrates a close-up view of the alignment features 200 of FIG. 20. The alignment feature 200 in the edge region is a vertical alignment feature 204 and aligns with an alignment feature in a central region of another photovoltaic component. The alignment feature 200 in the center region includes both a vertical alignment feature 204 and a horizontal alignment feature 202.

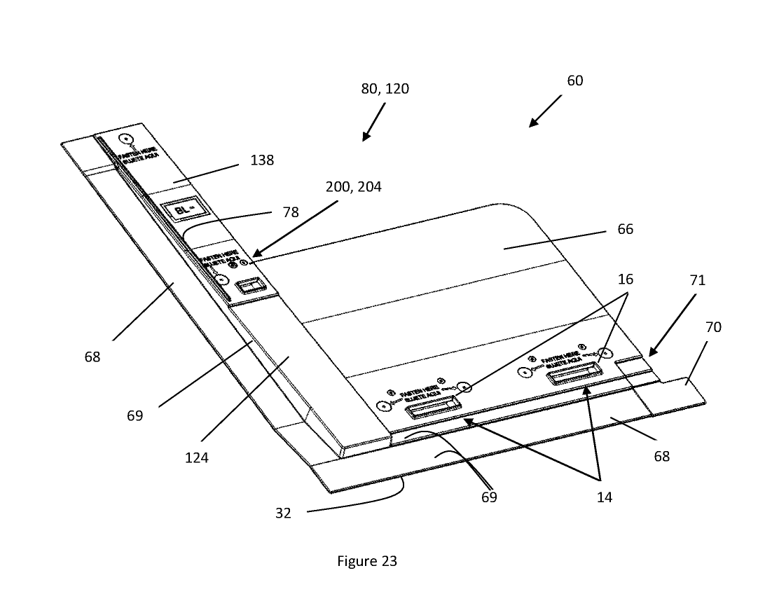

FIG. 22 illustrates a flashing component 60 that as shown is both a corner piece 80 and a row to row flashing piece 120. The flashing component 60 is a bottom right minus piece 126. The bottom right minus piece 126 includes a row to row connector portion 138 that extends between two adjacent rows and an overlap portion 66 extending from the row to row connector portion 138. The row to row connector portion 138 includes a flashing interface 68 and flashing walls 69 that prevent fluid from entering the photovoltaic array (not shown) and an alignment feature 200 that is a vertical alignment feature 204. The flashing interface 68 and flashing walls 69 extend from the row to row connector portion 138 and partially around the overlap portion 66. An alignment rib 78 extends along a portion of the flashing walls 69 and assists in forming a connection with an adjacent photovoltaic component. An end of the flashing interface 68 includes a flashing extension 70. The overlap portion 66 receives a photovoltaic component and preferably a photovoltaic module (not shown) so that a connection member of the photovoltaic component forms a connection with the connection members 10 of the bottom right minus piece 126. The connection members 10 are connection recesses 14 that include walls 16 that extend around the connection recesses 14.

FIG. 23 illustrates a top perspective view of a flashing component 60 that serves as both a corner flashing piece 80 and as a row to row flashing piece 120. The flashing component 60 is a bottom left minus piece 124 and includes an overlap portion 66 and a row to row connector portion 138. The row to row connector portion 138 extends outward so that the row to row connector portion 138 connects the row to row flashing piece 120 to a photovoltaic component in its row as well as an adjacent row (shown in FIG. 1). The row to row connection portion 138 includes an alignment rib 78 that forms a connection with an alignment slot 79 (not shown). The row to row connector portion 138 includes a flashing interface 68 that extends over another photovoltaic component or a roofing component to form a seal to resist penetration of fluids. The row to row connector portion 138 includes an alignment feature 200, which as shown is a vertical alignment feature 204. The flashing interface 68 at this point extends along to sides of the bottom left minus piece 124 so that a corner is created. A flashing wall 69 is adjacent to the flashing interface 68 and the flashing wall 69 creates a barrier and prevents fluid from extending from the flashing interface 68 onto the photovoltaic array (not shown). Two flashing walls 69 are located proximate to the bottom edge 32 so that a double tortuous path is created. The row to row connector portion 138 is connected to an overlap portion 66 that extends therefrom. The overlap portion 66 includes a pair of connection recesses 14 for receiving a connection hook (not shown) of an adjacent photovoltaic component. Each of the connection recesses 14 include a wall 16 that extends around the periphery of the connection recess 14 and prevents fluid from extending into the connection recess 14. A flashing extension 70 extends from the overlap portion 66 that extends under an adjacent photovoltaic component (not shown) so that water is prevented from penetrating between the bottom left minus piece 124 and the adjacent photovoltaic component. A pocket 71 is located adjacent to the flashing extension 70 and the pocket 71 receives a flashing extension 70 from an adjacent photovoltaic component to assist in preventing fluid penetration. The flashing extensions 70 also assist in locating two or more photovoltaic components together.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A photovoltaic array system comprising:
a plurality of photovoltaic components in a plurality of staggered rows that are configured to be connected together; and
one or more visual alignment features located on at least two of the plurality of photovoltaic components;
wherein the one or more visual alignment features are located in a side edge region of at least one of the plurality of photovoltaic components and in a top edge region of at least one of the plurality of photovoltaic components, and the one or more visual alignment features indicate when two or more of the plurality of photovoltaic components are aligned relative to each other so that the two or more photovoltaic components can be mated together to form a fixed connection and wherein at least one of the one or more visual alignment features includes one or more horizontal visual alignment features, one or more vertical visual alignment features, or both.

2. The photovoltaic array system of claim 1, each of the plurality of photovoltaic components include one or more connection members and the one or more connection members are concealed from view during formation of a connection.

3. The photovoltaic array system of claim 2, wherein the one or more connection members are one or more connection hooks, one or more connection recesses, or a combination of both.

4. The photovoltaic array system of claim 3, wherein the one or more connection hooks of one photovoltaic component extend into the one or more connection recesses of an adjacent photovoltaic component so that the photovoltaic components are connected together.

5. The photovoltaic array of claim 3, wherein the one or more connection hooks are located on a bottom side of photovoltaic component and concealed from view during installation.

6. The photovoltaic array system of claim 3, wherein the one or more connection recesses are covered by one or more adjacent photovoltaic devices so that the one or more connection recesses are concealed from view during installation.

7. The photovoltaic array system of claim 1, wherein the visual alignment features comprise a series of shapes, series of lines, recesses, bumps, indentations, raised surfaces, or a combination thereof.

8. The photovoltaic array system of claim 1, wherein the one or more horizontal alignment features provide an alignment location along a length of one of the photovoltaic components relative to an adjacent photovoltaic component so that an edge of adjacent photovoltaic component is aligned with one of the one or more horizontal alignment features.

9. The photovoltaic array system of claim 1, wherein the one or more horizontal alignment features are located in a central portion of one or more of the plurality of photovoltaic components.

10. The photovoltaic array system of claim 1, wherein at least one of the plurality of photovoltaic components includes one or more vertical alignment features that are a single alignment feature located proximate to one or both edges of one or more of the plurality of photovoltaic components.

11. The photovoltaic array system of claim 10, wherein the one or more vertical alignment features provide an alignment location along a height of one of the active components or flashing components relative to an adjacent photovoltaic component.

12. The photovoltaic array system of claim 3, wherein each of the plurality of photovoltaic components include the one or more vertical alignment features and the vertical alignment features are aligned relative to each other so that the photovoltaic components are connected together and then one of the photovoltaic components is moved so that the vertical alignment feature of an adjacent photovoltaic component aligns with a top edge of the photovoltaic component.

13. The photovoltaic array system of claim 9, wherein the one or more horizontal alignment features bisect the photovoltaic component so that one adjacent photovoltaic component is located on each side of the horizontal alignment feature and each of the adjacent photovoltaic components form a connection with the photovoltaic component.

14. A method of forming a photovoltaic array comprising:
placing one or more photovoltaic components in a first row or column;
placing one or more photovoltaic components in a second row or column that at least partially overlaps the first row or column;
aligning the one or more photovoltaic components in the second row or column with the one or more photovoltaic components in the first row or column using one or more visual alignment features;
locking the one or more photovoltaic components in the second row or column to the one or more photovoltaic components in the first row or column by moving the one or more photovoltaic components in the second row or column relative to the one or more visual alignment features.

15. The method of claim 14, wherein the one or more visual alignment features are located in a central region of at least one of the one or more photovoltaic components in the first row or column and on one or both edges of at least one of the one or more photovoltaic components in the second row or column.
